(19) United States
(12) Patent Application Publication
(10) Pub. No.: US 2024/0239084 A1
(43) Pub. Date: Jul. 18, 2024

(54) IR-REFLECTIVE COMPOUND INTERLAYERS

(71) Applicant: SOLUTIA INC., ST. LOUIS, MO (US)

(72) Inventors: STEVEN V. HALDEMAN, HAMPDEN, MA (US); LORA LEE SPANGLER, BELCHERTOWN, MA (US); FRANCOIS ANDRE KORAN, LONGMEADOW, MA (US); JEFFREY B. HURLBUT, WEST SPRINGFIELD, MA (US)

(73) Assignee: SOLUTIA INC., ST. LOUIS, MO (US)

(21) Appl. No.: 18/562,869

(22) PCT Filed: Jun. 23, 2022
(86) PCT No.: PCT/US2022/034657

§ 371 Date: Nov. 21, 2023

Related U.S. Application Data
(60) Provisional application No. 63/215,108, filed on Jun. 25, 2021.

(51) Int. Cl. B32B 17/10; B32B 7/027; G02B 27/00; G02B 27/01; G02B 27/28

(52) U.S. Cl. CPC B32B 17/1044; B32B 7/027; B32B 17/10036; B32B 17/1022; B32B 17/10568; B32B 17/10605; B32B 17/10761; G02B 27/0018; G02B 27/0103; B32B 2307/308; B32B 2307/7376; B32B 2605/00; G02B 2027/011; G02B 2027/0194; G02B 27/283

(57) ABSTRACT

Windshields are disclosed herein having an optical path, that include an inner rigid substrate, optically adjacent a first wedge polymer layer, that serves to reflect a primary image. A reflective layer is also provided, positioned in the optical path between the first wedge polymer layer and a second wedge polymer layer. The windshields are further provided with an outer rigid substrate, optically adjacent the second wedge polymer layer. The first wedge polymer layer causes visible light reflected from the reflective layer to overlap the primary image, and the second wedge polymer layer causes visible light reflected from an outer face of the outer rigid substrate to overlap the primary image.

### BACKGROUND OF INVENTION

Recent years have seen a significant increase in the functionality provided by automotive windscreens. While optical transparency, impact resistance, and durability remain key performance criteria, a host of new functionalities are being sought after by the consumer. These include sound damping, energy management, and display capabilities.

Incorporating multiple performance features in a single windshield brings value to the customer, but often necessitates a compromise to overall performance, as individual performance elements invariably work against each other. Creation of a final product incorporating multiple functionalities typically requires a careful selection of properties to create a balance that compromises on each element while still bringing overall value. Yet, in some cases, it is possible to develop novel ways to design a product that bring together different functionalities in ways that require little to no compromise to performance or functionality.

One set of functionalities particularly desirable in automotive windscreens is the combination of energy management and display capabilities. Head-up Display (HUD) technology in windscreens is an automotive trend that is seeing large growth rates due to customer demand, and is being enabled by improved projector technologies, enhanced informatics/infotainment features, and the evolution of advanced driver-assist systems and autonomous driving systems.

Energy management technologies, mainly in the form of infrared heat rejection, have been used for years in automotive applications to improve driver comfort and reduce thermal load to the cabin. While there is a clear market demand for windshields that combine solar protection with head up display capabilities, the combination invariably leads to unacceptable optical artifacts. It is the intent of this invention to outline one such method for combining the elements of energy management and head up display capabilities with essentially no compromise to final product performance in each category. The key to doing so requires a better understanding of the physics that describes the way electromagnetic radiation interacts with a windshield.

In energy management applications, windshields often incorporate films designed to reflect electromagnetic energy. These films often comprise transparent polymeric substrates onto which extremely thin metal stacks of alternating refractive index have been sputtered. The material selection and sputtering thicknesses are selected to favor reflection in the near and far infrared regions while minimizing effects to the visible light spectrum. Several such products have been described.

U.S. Pat. No. 5,071,206 discloses visually transparent, color corrected, infrared reflecting films for solar heat control. The films employ Fabry-Perot sandwich interference filters, which are characterized by having three or more transparent layers of sputter-deposited metal, such as silver, directly contiguous with dielectric spacer layers and, optionally, boundary layers. Methods for producing these materials by sputtering techniques, as well as subsequent glazing methods for incorporating these films, are disclosed as well.

Similarly, U.S. Pat. No. 6,416,872 discloses a heat reflecting transparent window cover having three layers. The composite has a substrate and a unique heat reflective stack disposed upon the substrate. The heat reflective stack has, in series, a first interference layer, an infrared-reflecting metal layer, a second interference layer and a first non-infrared reflective layer. The first interference layer has an index of refraction which differs from the index of refraction of the substrate by at least about 0.1. The first non-infrared reflective layer is composed of the material from one of the following groups of materials: (i) metals having an index of refraction greater than about 1.0 and an extinction coefficient greater than about 2.0, and (ii) non-metals having an index of refraction greater than about 0.5 and an extinction coefficient greater than about 0.5.

It is important to note that while these infrared rejection films act mostly on the near and far infrared regions, the visible light spectrum is also affected. This is important because in this part of the electromagnetic spectrum, such films will affect the performance of most traditional head up display technologies.

Head up displays use visible light to transmit and communicate information to a driver. In a common form, a head-up-display (HUD) automotive system may comprise a computerized signal generator, a projector, and a laminated glass windscreen system that acts as a reflection screen for the projected image. Images generated by the computerized signal generator are fed to the projector, which generates light patterns, expands and collimates the light images through a series of mirrors, and projects the images towards the windscreen at a specially selected angle designed for high reflection intensity.

As the projected image hits the inner surface of the windshield, that is, the air-glass interface, it encounters a significant change in refractive index, causing part of the image intensity (light) to be reflected off the surface in the direction of the driver eyebox. This image, termed the primary image, travels to the driver's pupils in the form of visual information. The part of the image that is not reflected at the inner glass surface continues through the PVB and glass, with only small changes to refraction angle resulting from minor variations in refractive indices between the glass and polymer interlayer(s). Once the transmitted light reaches the outer glass surface, it encounters a large refractive index change at the air interface and a portion of the light is reflected back in. This reflected image travels back through the laminate and a significant portion emerges from the laminate traveling to a point outside of the driver's eyebox (thus unseen).

There exists, however, a second series of light rays emerging at a slightly different angle from the projector that travels a similar path into and back out of the laminate that is reflected at an angle such that the reflection off the outer glass surface is visible to the driver. This is typically referred to as the secondary image. When the front and rear glass lites in a laminate are essentially parallel to each other, the primary and secondary images are slightly offset, such that the secondary image appears to be a lower intensity ‘ghost’ image of the primary image.

In most commercial applications, OEMs make use of wedged PVB interlayers to create an angle between the inner and outer glass lite, thus bringing the secondary image into alignment with the first. This technique is quite effective, but difficult to accomplish perfectly, and the automotive industry has thus been actively working on developing ways to reduce the visibility of secondary reflection ghost images.

U.S. Pat. No. 8,451,541 discloses that interfering double images that occur with curved windshields made from laminated glass during night driving in transmission, and with head-up displays in reflection, can be reduced by a wedge-shaped thermoplastic intermediate film. The wedge-angle profile required for compensation of double images is determined locally as a function of pane shape and installation situation. If the vehicle has a head-up display system, the wedge-angle progression can be determined in the HUD field such that double images are prevented there in reflection. However, outside the HUD field, a wedge-angle progression that compensates double images in transmission is selected. The specifically adapted wedge-angle profile enables better compensation of double images than is possible with a film with a constant wedge angle.

U. S. Pat. Publn. No. 2017/0285339 discloses tapered interlayers and windshields employing them. Unlike conventional windshields, which are optimized to reduce ghost images for a single driver height, the windshields of this disclosure may exhibit reduced ghosting for drivers of multiple heights, including very tall or very short drivers, while also providing desirable image clarity for average-height drivers. The windshields described may be used in a variety of applications, including automotive, aircraft, marine, and recreational vehicles that employ HUD projection systems.

Although improvements to head up display optics continue to be developed, one significant problem remains for applications which combine both solar control and head up display capabilities. The root of these problems arises from the fact that reflecting films incorporated into windshields with head up displays partially reflect in the visible light region, interfering with the HUD optics. More specifically, when these films are laminated between the inner and outer glass lights, a visible third refection is created in the HUD zone, causing the driver to see two distinct ghost images. Employing the standard wedged PVB layers used in the industry can cause the original ghost or secondary image to overlap onto the primary image but the new tertiary ghost image will not overlap.

There thus remains a need in the art for interlayers for glass laminates that can reject infrared light by reflection while preventing ghosting that can occur from reflection of visible light from the reflective layer.

### SUMMARY OF INVENTION

In one aspect, the invention relates to a windshield having an optical path, that includes an inner rigid substrate, optically adjacent a first wedge polymer layer, that serves to reflect a primary image. The windshield is further provided with a reflective layer, positioned in the optical path between the first wedge polymer layer and a second wedge polymer layer; and an outer rigid substrate, optically adjacent the second wedge polymer layer. According to the invention, the first wedge polymer layer causes visible light reflected from the reflective layer to overlap the primary image, and the second wedge polymer layer causes visible light reflected from an outer face of the outer rigid substrate to overlap the primary image.

Further aspects are as disclosed and claimed herein.

### BRIEF DESCRIPTION OF THE DRAWINGS

FIG. 1 depicts a schematic partial view of a vehicle employing a HUD system.

FIGS. 2a and 2b depict a windshield configured according to embodiments of the present invention.

FIG. 3 depicts one embodiment of an interlayer having an at least partially tapered thickness profile and wedge angle profile that are useful according to the present invention.

FIG. 4 depicts another embodiment of an interlayer having an at least partially tapered thickness profile and wedge angle profile that are useful according to the present invention.

FIG. 5 depicts a further embodiment of an interlayer having an at least partially tapered thickness profile and wedge angle profile that are useful according to the present invention.

FIG. 6 depicts yet another embodiment of an interlayer having an at least partially tapered thickness profile and wedge angle profile that are useful according to the present invention.

FIG. 7 depicts a further embodiment of an interlayer having an at least partially tapered thickness profile and wedge angle profile that are useful according to the present invention.

FIG. 8 depicts another embodiment of an interlayer having an at least partially tapered thickness profile and wedge angle profile that are useful according to the present invention.

FIG. 9 depicts yet another embodiment of an interlayer having an at least partially tapered thickness profile and wedge angle profile that are useful according to the present invention.

FIG. 10 depicts a further embodiment of an interlayer having an at least partially tapered thickness profile and wedge angle profile that are useful according to the present invention.

FIGS. 11a and 11b depict further embodiments of interlayers having an at least partially tapered thickness profile and wedge angle profile that are useful according to the present invention.

FIG. 12a depicts an example of the double image separation experienced by short and tall drivers, as compared to drivers of “nominal” height for conventionally optimized interlayers.

FIG. 12b depicts a windshield configured according to an aspect of the present invention to minimize reflected double image separation for all driver heights, providing a clearer, more readable virtual image at all heights.

FIGS. 13a and 13b depict schematic diagrams of an experimental set up for testing the reflected double image separation distance of a windshield.

FIG. 14 depicts a graph of intensity as a function of pixel number.

FIG. 15 depicts a thickness profile of an actual wedge interlayer for use in the windscreen of a HUD system.

FIG. 16 depicts the plot of the actual local wedge angle variation from target of the wedge interlayer of FIG. 15.

FIG. 17 is a plot of the rate-of-change of the local wedge angle deviation of the wedge interlayer depicted in FIG. 16.

FIG. 18 shows an example of an image captured off of a non-wedge laminate containing a metalized IR reflective film.

FIG. 19 shows a plot of pixel intensity of a vertical line trace running through the approximate center of an image.

FIG. 20 depicts a single line image observed in a non-wedge interlay, showing no ghost imaging.

FIG. 21 depicts a HUD line image in which three lines are observed.

FIG. 22 depicts a HUD line image in which two lines are observed.

FIG. 23 depicts a HUD line image in which two lines are observed.

FIG. 24 depicts a HUD line image in which a single line is observed with no ghost image.

### DETAILED DESCRIPTION

Thus, in a first embodiment, the invention relates to windshields having an optical path, that include an inner rigid substrate, optically adjacent a first wedge polymer layer, that serves to reflect a primary image; a reflective layer, positioned in the optical path between the first wedge polymer layer and a second wedge polymer layer; and an outer rigid substrate, optically adjacent the second wedge polymer layer. According to this embodiment, the first wedge polymer layer causes visible light reflected from the reflective layer to overlap the primary image, and the second wedge polymer layer causes visible light reflected from an outer face of the outer rigid substrate to overlap the primary image.

A second embodiment is according to the first embodiment, and further provides that the visible light reflected from the reflective layer and the visible light reflected from the outer face of the outer rigid substrate each overlap the primary image with an image separation distance of less than about 1.5 arc-min.

A third embodiment is according to either of the first two embodiments, and further provides that at least one of the first wedge polymer layer and the second wedge polymer layer has a surface with a waviness index of less than 20,000 square micrometers, an Rz value of at least 20 micrometers, and a permanence of between 10 and 95.

A fourth embodiment is according to any of the preceding embodiments, and further provides that at least one of the first wedge polymer layer and the second wedge polymer layer has an absolute wedge angle variation from target that is less than 0.1 mrad and the 50 mm rate of change of the wedge angle is less than 4 μrad per millimeter.

A fifth embodiment is according to any of the preceding embodiments, and further provides that the reflective layer selectively reflects infrared light.

A sixth embodiment is according to any of the preceding embodiments, and further provides that the first wedge polymer layer and the second wedge polymer layer comprise poly(vinyl acetal).

A seventh embodiment is according to any of the preceding embodiments, and further provides that the first wedge polymer layer and the second wedge polymer layer have a thickness from about 0.05 mm to about 1.2 mm.

An eighth embodiment is according to any of the preceding embodiments, and further provides that the first wedge polymer layer and the second wedge polymer layer have a thickness from 0.1 mm to 1.0 mm.

A ninth embodiment is according to any of the preceding embodiments, and further provides that the first wedge polymer layer and the second wedge polymer layer comprise poly(vinyl acetal) and have the same thickness.

A tenth embodiment is according to any of the preceding embodiments, and further provides that the first wedge polymer layer and the second wedge polymer layer are positioned as mirror images of one another.

An eleventh embodiment is according to any of the preceding embodiments, and further provides that at least one of the first wedge polymer layer and the second wedge polymer layer comprise at least one skin layer and at least one core layer.

A twelfth embodiment is according to any of the preceding embodiments, and further provides that one of the wedge polymer layers comprises: at least a first layer comprising a first poly(vinyl acetal) resin having a first residual hydroxyl content and a first residual acetate content, and a first plasticizer, wherein the first layer has a glass transition temperature (T_{g}) greater than 26° C.; and a second layer comprising a second poly(vinyl acetal) resin having a second residual hydroxyl content, and a second plasticizer, wherein the second layer has a glass transition temperature (T_{g}) less than 20° C.

A thirteenth embodiment is according to any of the preceding embodiments, and further provides that at least one of the first wedge polymer layer and the second wedge polymer layer comprises at least one skin layer and at least one core layer and has a thickness from about 0.1 mm to about 1.0 mm.

A fourteenth embodiment is according to any of the preceding embodiments, and further provides that at least one of the first wedge polymer layer and the second wedge polymer layer does not comprise at least one skin layer and at least one core layer, and has a thickness from about 0.1 mm to about 1.0 mm.

A fifteenth embodiment is according to any of the preceding embodiments, and further provides that the reflective layer comprises a holographic optical element.

A sixteenth embodiment is according to any of the preceding embodiments, and further provides that the reflective layer comprises a metallized film.

A seventeenth embodiment is according to any of the preceding embodiments, and further provides that the reflective layer comprises a film having alternating layers of a low refractive index material and a high refractive index material deposited thereon.

An eighteenth embodiment is according to any of the preceding embodiments, and further provides that the reflective layer polarizes light.

A nineteenth embodiment is according to any of the preceding embodiments, and further provides that the reflective layer preferentially reflects a particular polarization of light.

A twentieth embodiment is according to any of the preceding embodiments, and further provides that the reflective layer comprises a film having alternating layers of a low refractive index polymer and a high refractive index polymer.

According to one aspect, then, the invention relates to a compound interlayer, comprising a reflective layer; a first wedge polymer layer, positioned on a first side of the reflective layer, so as to redirect visible light reflection from the reflective layer; and a second wedge polymer layer, positioned adjacent a second side of the reflective layer so as to redirect visible light reflection from an outer face of a glass lite when an inner face of the glass lite is placed adjacent the second wedge polymer layer.

According to various aspects, the reflective layer may selectively reflect infrared light. Typically, the reflective layer desirably reflects infrared light, for example that entering a vehicle, but disadvantageously also reflects some amount of visible light, for example that coming from an HUD, creating an unwanted reflection.

A variety of reflective films may be used according to the invention. The structure or fabrication technique of the reflective film is unimportant, as long as it reflects some amount of light in the visible spectrum, for example that used by the HUD display system.

In some cases, the reflective layer will comprise a metallized film, as further described herein. In a further embodiment, the reflective layer may comprise or further include alternating layers of a low refractive index polymer and a high refractive index polymer. In yet others, the reflective layer may comprise a series of holographically produced optical elements, with carefully controlled regions of low and high refractive index domains.

In some aspects, the reflective layer may desirably polarize light. In other aspects, the reflective layer preferentially reflects a particular polarization of light. In specific variants, the film reflects substantially only in the visible region, or the UV and visible regions, but not the infrared region. In another aspect it reflects in all three regions.

In considering the windshields of the invention as used in practice, we can refer to the windshields as having four rigid substrate surfaces or interfaces. The first interface, or inner surface of the windshield or glazing, is the interface between the air inside the vehicle and the first surface of the first glass lite. This is the interface with which the primary image is reflected to the viewer. The second interface is at the second surface of the first glass lite, or other rigid substrate, and the interlayer. The third interface is that between the interlayer and the first surface of the second glass lite, and the fourth interface, or outer surface of the glazing, is that between the exterior (second) surface of the second glass lite and the air. It is understood that in this description, the compound interlayer is comprised of multiple components including the two wedge polymer layers, and the reflective layer. The reflective layer may comprise an HOE film, a metallized film, or other embodiment described herein.

As used herein, “primary image” may thus refer to the visible light part of a projected image that is reflected off a display surface in the direction of the driver, sometimes referred to as the “driver eyebox”. This primary image is an intended image which is reflected and travels to the driver's pupils in the form of visual information. The reflections that create the primary image are a result of projected light encountering a significant change in refractive index at the first interface, causing part of the image intensity (light) to be reflected.

As used herein, a “secondary image” is distinct from the “primary image.” Instead of reflecting from an intended display surface toward a viewer, the secondary image arises from unwanted reflections such as those created by the refractive index difference between the outside of the second transparent rigid substrate of the glazing and the exterior air.

As used herein, a “tertiary image” is distinct from the “primary image” and “secondary image.” Instead of reflecting from an intended display surface toward a viewer, or from the outside of the second transparent rigid substrate of the glazing, the tertiary image arises from unwanted visible light reflections such as those created by the refractive index difference at the reflective layers.

According to the present invention, certain of the visible light reflections to be caused to overlap or align with the primary image are caused by light from a HUD projector reflecting from the reflective layer. The second wedge polymer layer of the invention is provided between the reflective layer and the outer surface of the glazing or other outer rigid substrate, thus causing the visible light reflection from the reflective layer to overlap with the primary image.

When we say that reflections or images overlap, we mean that they substantially overlap, such that they are less perceptible as separate images, or in some cases, appear to be the same image. It is understood that there may be portions of the image or reflection that overlap more than others. Although perfect overlap of images would be most desirable, this is difficult in practice to achieve.

According to the present invention, both a first wedge polymer and a second wedge polymer are provided so that both the secondary and tertiary images overlap onto the primary image. The first wedge polymer layer is designed to cause visible light reflected from the reflective layer to overlap the primary image, while the combined optical path created by the first and second wedge polymers causes the light reflected from the outer glass surface to also overlap the primary image.

It is understood that the benefits of the invention may be captured regardless of the method of manufacture or intended properties of the film, as long as the film reflects visible light, typically that in the same wavelengths as employed in the HUD systems, and inasmuch as carrying out the invention mitigates the additional ghost images generated by such a film.

In one approach, the reflective layer comprises a film having alternating layers of a low refractive index material and a high refractive index material deposited thereon. In others, the alternating layers are manufactured together, such as in a coextrusion process, for example. In yet others, the materials may be mixed together and subsequently formed into refractive index zones through thermal, light, or mechanical processes. An exemplary subset of this approach is the formation of high and low refractive index zones using high intensity light patterning of volume holographic films. In another aspect, metals or metal oxides are added in alternating layers of high and low refractive index, for example by sputtering, chemical vapor deposition, or the like.

In one aspect, the invention comprises a compound interlayer that is provided with a reflective layer, for example an IR-reflective layer, combined with wedge polymer layers. When we say “compound interlayer,” we mean to describe an interlayer having at least a reflective layer and two wedge polymer layers. Additional layers may be present, if desired, between the stated layers or outside the stated layers, so long as the compound interlayer is still useful for its intended purpose. These compound interlayers may also be described herein as “stacks.”

The reflective layers according to the invention are not especially limited. In a preferred application, the reflective layer may be any layer that reflects light, and typically will desirably selectively reflect infrared light, while reflecting minor amounts of visible light, which may be a disadvantage. When we say that the reflective layer may selectively reflect infrared light, we mean that it is designed to reflect wavelengths from the nominal red edge of the visible spectrum around 700 nanometers and above, or from about 700 to about 2500 nm, or from 700 nm to 1200 nm, that is, above the visible light spectrum. Reflective layers that selectively reflect in this wavelength range are understood to block heat, since the wavelengths that are reflected will not, for example, enter an automobile and heat up the interior. It will be understood that if the reflective layer is intended for use in a vehicle with a HUD system, reflections of visible light by the reflective layer, for example that emanating from the HUD projector, are typically undesirable and should be minimized. The compound interlayers of the invention serve to minimize the ghosting or the driver perceived visibility of undesired reflections, including that caused by the reflective layer. In one aspect, the reflective layers of the invention may include those disclosed and claimed in U.S. Pat. No. 5,071,206, the relevant disclosure of which is incorporated herein by reference.

Thus, “visible radiation” or “visible light” means electromagnetic radiation having a wavelength of from about 380 nanometers to about 750 nanometers, or from about 400 nanometers to about 700 nanometers, while “Infrared radiation” or “heat” means electromagnetic radiation having a wavelength above about 700 nanometers, or above about 750 nanometers, or as described elsewhere herein.

“Transparent” means having the property of transmitting visible light, unless otherwise stated.

“Tvis” or “Tv” or “Transmittance visible” each refer to a measure of transmittance over the visible wavelength. It is an integrated term covering the area under the transmittance vs. wavelength curve throughout the visible wavelengths. (1931 CIE Illuminant A Standard). In automotive windshield glazing, Tvis should be 70% or greater.

“Tsol” or “Ts” or “Transmittance solar” each refer to a measure of transmittance over all solar energy wavelengths. (ASTM E 424A) It is an integrated term covering the area under the transmittance vs. wavelength curve for both visible and infrared wavelengths. In many heat reflecting films, and glazings incorporating them, it is a primary goal to decrease Tsol while maintaining Tvis as high as possible.

“SC” or “Shading Coefficient” is an accepted term in the field of architecture. It relates the heat gain obtained when an environment is exposed to solar radiation through a given area of opening or glazing to the heat gain obtained through the same area of ⅛ inch single pane clear glass. (ASHRAE Standard Calculation Method) The clear glass is assigned a value of 1.00. An SC value below 1.00 indicates better heat rejection than single pane clear glass. A value above 1.00 would be worse than the baseline clear single pane. A similar term is “R.sub.sol” or “reflectance, solar”, which is measure of total reflectance over the solar energy wavelength.

“Transparent metal layers” are homogeneous coherent metallic layers composed of silver, gold, platinum, palladium, aluminum, copper or nickel and alloys thereof of a thickness which permits substantial transparency.

“Sputter deposit” or “sputter-deposited” refers to the process or the product of the process in which a layer of material is laid down by the use of a magnetron sputterer.

“Dielectrics” are nonmetallic materials which are transparent to both visible and infrared radiation. Generally, these materials are inorganic oxides but other materials such as organic polymers may be included as well.

“Contiguous” has its usual meaning of being in actual contact, i.e. of being adjoining. From time to time the somewhat redundant term “directly contiguous” is used for emphasis or clarification and has an identical meaning.

“Adjacent” means that the layers referred to are functionally related to one another. That is, layers are adjacent if, for example, light intended to pass through both layers indeed passes through both layers, with any layers lying between adjacent layers not blocking the intended function, in this case to pass light through the layers.

“Optically adjacent” thus means that the layers function together optically, that is, they are positioned in an optical path. The term “optically adjacent” thus allows for additional materials to be placed between optically adjacent layers, so long as they are in the same optical path.

When we say that the films, interlayers, or windshields of the invention have an optical path, we mean that there is a path that allows the light to pass through. Thus, if a layer is placed in the optical path, it will be to at least some or a significant extent transparent. Because the invention relates to minimizing unwanted reflections, any number of additional materials may be added to the optical paths of the systems of the invention so long as they do not detract from the desired effect.

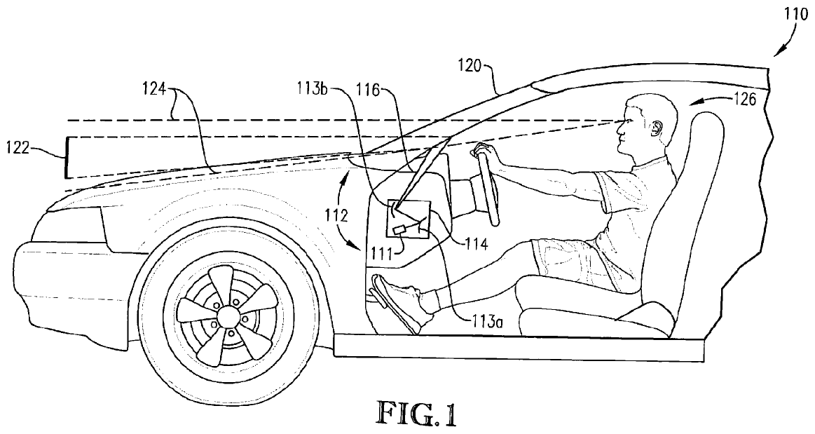

A “spacer layer” is a dielectric layer located between and contiguous with or adjacent to two transparent metal layers. In FIG. 1, 18 is a spacer layer.

A “boundary layer” is a layer contiguous with at least one functional layer, but typically does not provide functionality other than tying the layers together.

In other aspects, the reflective layer preferentially reflects a particular polarization of light. In the coordinate system relating to the plane of incidence, such a reflection layer may be used to preferentially reflect s-polarized light, or in other instances p-polarized light, depending on design of the HUD system, or in some cases to enable the use of polarized sunglasses with the HUD system.

In one aspect, then, the present invention involves infrared- or heat-reflecting layers, or filters. A basic embodiment of these filters is a multilayer interference filter directly adhered to a transparent support. Such filters operate according to the Fabry-Perot principle and include one or more transparent metal layers, separated by spacer layers, and bonded by two outer or boundary layers. Thus, it presents two cavities between metal layers.

In preferred embodiments of this filter, the transparent metal layers may be sputter-deposited. In addition, the spacer and boundary layers can be directly contiguous with the transparent metal layers. No nucleation layers are required when the transparent metal layers are sputter-deposited. Nucleation layers may be present if desired.

In one aspect, more than three transparent metal layers, each separated from one another by a spacer layer can be employed. In theory, there is no limit to the number of transparent metal layers that can be used in these sandwich filters. In practice, however three to five transparent metal layers may be preferred, with three transparent metal layers being suitable.

The thickness of the various layers in the filter should be controlled to achieve an optimum balance between desired infra-red reflectance and desired visible radiation transmittance. The ideal thicknesses can also depend upon the nature of the transparent metal and dielectric employed.

Each of the transparent metal layers may be, for example, from about 4 to about 40 nanometers (nm) in thickness, with the total thickness of metal in the reflective layer being, for example, from about 12 to about 80 nm. With silver and silver alloyed with up to about 25% wt of gold, which constitute preferred transparent metals, excellent results are obtained with three or four layers of metal, each from 4 to 17 nm in thickness especially from about 5 to about 13 nm.

Although the three transparent metal layers may be of equal thickness, this is not a requirement of the present invention. Satisfactory results have been achieved when the middle of the three metal layers is about 5% to 15%, especially 10% thicker than each of the outer layers.

The metal layers can be deposited by vapor deposition methods, electron-beam deposition, and the like. Magnetron sputtering is a preferred deposition method, but any methods which can deposit 100 nm layers with 10% accuracy, for example, can be used.

The spacer layers between the transparent metal layers can be the same or different and are each between about 30 and about 200 nm in thickness. The thicknesses selected within this range will depend upon the index of refraction of the dielectric employed. Index of refraction values can be from about 1.4 to 2.7. In a general relationship, thicker layers are called for with low index material while thinner layers are used with higher index material. Spacer layers are preferably from about 50 to about 110 nm and especially from about 70 to about 100 nm in thickness for dielectrics having an index of refraction of from about 1.75 to about 2.25. Materials having an index of refraction within this range include the inorganic dielectrics such as metallic and semimetallic oxides, for example zinc oxide, indium oxide, tin oxide, titanium dioxide, silicon oxide, silicon dioxide, bismuth oxide, chromium oxide, as well as other inorganic metal compounds and salts, for example zinc sulfide and magnesium fluoride and mixtures thereof. Of these materials, preference is given to zinc oxide, indium oxide, tin oxide and mixtures thereof and titanium dioxide.

With materials having indices of refraction in the 1.4 to 1.75 range, spacer thicknesses are somewhat thicker. Suitable thicknesses in this embodiment are from about 75 to about 200 nm with thicknesses from about 100 to about 175 nm being preferred. Materials having these indices of refraction include hydrocarbon and oxyhydrocarbon organic polymers (1.55-1.65 index of refraction) and fluorocarbon polymers (1.35-1.45 index of refraction).

With materials having indices of refraction in the 2.25 to 2.75 range, spacer thicknesses may be somewhat thinner. Suitable thicknesses in this embodiment may be from about 30 to about 90 nm with thicknesses from about 30 to about 80 nm being preferred. Materials having these indices of refraction include lead oxide, aluminum fluoride, bismuth oxide and zinc sulfide.

Other typical inorganic dielectrics and their indexes of refraction are listed in sources such as Musikant, Optical Materials, Marcel Dekker, New York, 1985, pp. 17-96, and may be used.

As will be described below, the inorganic metallic and semimetallic oxide dielectrics can be conveniently and preferably deposited by reactive sputtering techniques, although, if desired, chemical vapor deposit and other physical vapor deposition methods can be employed to apply the dielectric layers.

The filters or reflective layers may include two boundary layers that provide physical protection to the metal layers beneath them and also serve to reduce visual reflections from the metal surface to which they are contiguous. It may be preferred to have a symmetric sandwich with boundary layers on both outside surfaces. This will give rise to a series of two or more sequential Fabry-Perot interference filters, each of the filters comprising a continuous discrete sputter-deposited solar transparent metal layer directly sandwiched between continuous layers of dielectric.

However, if desired, one or both of the boundary layers can be omitted. The boundary layers can be the same or different dielectric and can be identical to or different than the dielectric making up the spacers. The same preferences for materials recited for the spacer apply to the boundary layers and, for simplicity, it is preferred if the boundary layers and the spacer layers are all made of the same materials and if they are all sputter-deposited.

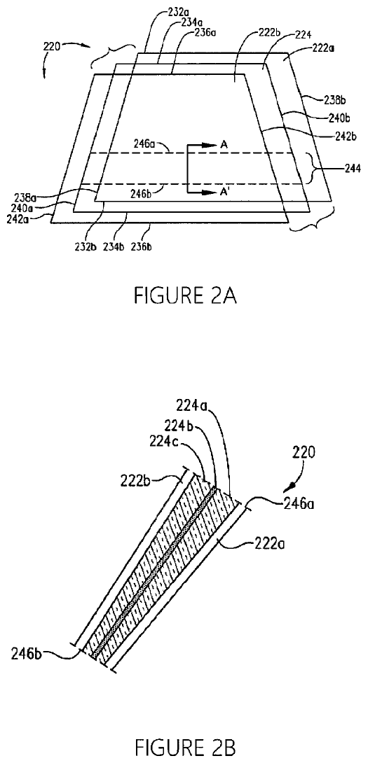

The thicknesses of the boundary layers may range, for example, from about 20 nm to about 150 nm. Boundary layers are typically from about 25 to about 90 nm and especially from about 30 to about 70 nm in thickness for dielectrics having an index of refraction of from about 1.75 to about 2.25. With materials having indices of refraction in the 1.4 to 1.75 range, preferred thicknesses are from about 30 to about 140 nm and especially from about 45 to about 100 nm. If, as shown in FIG. 2, three or more transparent metal layers are employed, the boundary layers will remain substantially unchanged.

To sum up the geometry of the presently preferred filters, they may, for example, have 7 layers arranged in a stack as follows: Boundary dielectric/Metal layer I/Spacer layer I/Metal layer II/Spacer layer II/Metal layer Ill/Boundary dielectric. In this configuration, the three metal layers are preferably silver and total from 25 to 35 nm in thickness with metal layer II being 110%.+−0.5% of the metal layers I or III. The boundary layers and spacer layers are preferably indium oxide with boundary layer thicknesses of from 30 to 40 nm and spacer thicknesses of from 60 to 80 nm.

According to this aspect, the Fabry-Perot type filter is typically directly adhered to a transparent support. This support is many times thicker than the filter. This thick support may be important to the practice of the invention. The filter itself is at most only a few hundred nanometers thick and thus can have only minimal physical strength without the added support. Support can be selected from among the rigid and nonrigid but minimally stretchable transparent solids which can withstand the conditions of sputter deposition. Glass, both float or plate glass and laminated glass and especially low iron float glass, and rigid plastics, such as poly(carbonate) and poly(acrylate) in thicknesses from about 50 mils to about 5 cm or more are representative examples of rigid supports. Poly(ester)s including poly(ethylene terphthalate) and other terphthalate ester polymers, poly(urethanes), cellulose ester polymers, acrylic polymers, and poly(vinyl fluoride)s from about 1 or 2 mils to about 50 mils in thickness are representative examples of nonrigid, minimally stretchable films which may be employed. Poly(esters) and in particular poly(ethylene terphthalates) are a preferred group of film supports.

The filter is directly adhered to the support. This can be carried out by sequentially applying the various layers of the filter directly to the support. If the layers are applied by sputter deposition, this can involve first sputter depositing a boundary layer, then a transparent metal layer, a spacer layer, etc.

The macroscale transparent layers, be they a plastic or glass transparent support or an additional component (such as a glass layer laminated to a plastic supported film), do contribute to the performance and visual optics of the final product.

In some settings, the desired optical properties of the reflective layer include maximum rejection (reflection) of heat (infrared wavelengths) with only less attention being paid to the amount of visible light transmitted or reflected. In other applications specific degrees of visible light transmittance must be attained to meet government regulations; for example, in automotive windshields the Tvis must be 70% or greater in most regions. Typically, reflectance is flat at 30% at all wavelengths between 350 nm and 700 nm. This means that the reflectance would be neutral in color, without any strong tint that could be found to be objectionable. In an idealized windshield, the reflectance would be 100% at the wavelengths outside the visible range to achieve maximum thermal rejection.

As previously noted, this aspect of the reflective layer of the invention permits one to control the color of reflectance off of the filter. In many cases the property is used to attain color neutrality. With colored light this means a colored reflection or with white light a neutral reflection. This feature can be quantitated by the CIE L*a*b* 1976 color coordinate system, in particular the ASTM 308-85 method.

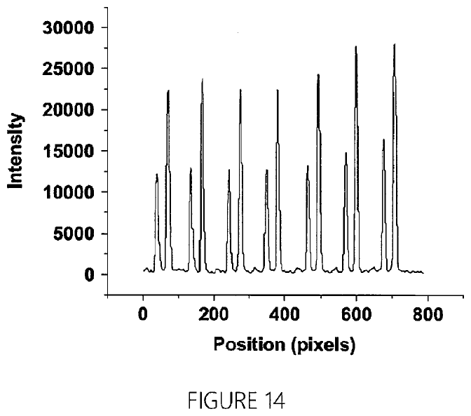

Using the L*a*b* system the property is shown by values for a* and b* near O for example a* from −4 to +1 and b* from −2 to +2 when using an Illuminant A light source. FIG. 14 is a L*a*b* color coordinant chart which shows the desired color coordinates and defines the desired color space.

This neutral color can also be illustrated by the shape of the absorbance/reflectance vs. wavelength curve and comparing it with a typical ideal curve.

In general, it will be observed that when the multimetal layer films of this aspect are laminated to or between plastic layers the overall optical properties are different than the properties observed with the unlaminated films. One achieves optical properties approaching the optimum in ways not easily achieved by less complicated filter stacks. In particular, one can achieve filter products having high Tvis/Tsol selectivity, neutral color, excellent heat rejection, high Tvis, high Rsol and an emissivity of less than 0.1.

In another aspect, the reflective layer may be a polymer stack, as disclosed, for example, in U.S. Pat. No. 5,103,337, the relevant disclosure of which is incorporated herein by reference. In this aspect, the reflective layer may comprise an optical interference film, made of multiple layers of polymers, which preferentially reflect wavelengths of light in the infrared region of the spectrum while being substantially transparent to wavelengths of light in the visible spectrum. Such an optical interference film includes multiple alternating layers of substantially transparent polymeric materials with differing indices of refraction.

As noted in U.S. Pat. No. 5,103,337, such multilayer films are also described in Alfrey et al, U.S. Pat. No. 3,711,176. When these polymers are selected to have a sufficient mismatch in refractive indices, the multilayer films cause constructive interference of light. This results in the film transmitting certain wavelengths of light through the film while reflecting other wavelengths. The multilayer films can be fabricated from relatively inexpensive and commercially available polymer resins having the desired refractive index differences. The films have the further advantage in that they may be shaped or formed into other objects.

As noted, the reflection and transmission spectra for a particular film are primarily dependent on the optical thickness of the individual layers, where optical thickness is defined as the product of the actual thickness of the layer times its refractive index. Films can be designed to reflect infrared, visible, or ultraviolet wavelengths of light depending on the optical thickness of the layers. When designed to reflect infrared wavelengths of light, such prior art films also exhibit higher order reflections in the visible range, resulting in an iridescent appearance for the films. The films produced in accordance with the above mentioned Alfrey patent exhibit iridescence and changing colors as the angle of incident light on the film is changed.

For some applications, such as windscreen interlayers used with HUD systems, reflection of infrared wavelengths is desirable, while higher order reflections of visible light are not. For example, infrared reflecting films can be laminated into automobile glass to reduce air conditioning loads. The films may also be laminated to other substantially transparent plastic materials to reflect infrared wavelengths. Ideally, the films must be substantially transparent to visible light so that the vision of those looking through the glass or plastic is not impaired.

In other aspects, the reflective layer may comprise a holographic optical element. A “hologram” as used herein refers generally to a physical recording of an interference pattern that uses diffraction to reproduce a three-dimensional light field, resulting in an image which may retain the depth, parallax, and other related properties of the original scene. In one aspect, a hologram is thus a recording of a light field rather than a recording of an image formed by a lens. The holographic medium may be unintelligible or indeed create unwanted light reflections and images when viewed under “normal” light, since it is an encoding of the light field as an interference pattern of variations in opacity, density, and surface profile of the medium. It is only when suitably lit that the interference pattern diffracts the light into an accurate reproduction of the original light field. This light is ideally provided by lasers, although in some uses this is impractical. In some reflection holograms, for example, white light may be used as an illumination source.

“Holographic optical elements” (or HOEs) as used herein refer to optical elements such as lenses, filters, beam splitters, or diffraction gratings, that may be produced using holographic imaging processes or principles, that modify light at at least one wavelength range, or at least two wavelength ranges, or at least three wavelength ranges, or more. In one aspect, the holographic optical elements function as angularly-selective reflective elements, or ASREs, reflecting desired wavelength range(s) in a desired direction while allowing other wavelengths and/or directions to pass through. These HOEs form the light of desired wavelengths such that the image seen by the viewer depends upon the angle from which it is viewed.

In most cases, HOEs will be patterned using a photopolymer film comprised of a substrate and photo-curing polymers of different refractive indices. HOE patterns can be imparted on the photopolymer however desired across the surface of the substrate. In some cases, the HOE patterning may cover the entire film or windshield, while in other cases, the HOE patterning may be limited to a smaller, HUD-reflecting area of substrate. Thus, when we say “HOE-patterned area,” we are referring to an area of the substrate that is the HOE, in that it modifies light as just described. In some embodiments the substrate may be glass. In other embodiments the substrate is a polymer film, for example PET, PA, or TAC. Regardless of the substrate, the final HUD product may incorporate the substrate, or it may be removed prior to incorporation into the HUD product.

According to one aspect of the invention, the display systems are thus provided with one or more of these holographic optical elements, which typically reflect light within three or more discrete wavelength ranges. In one aspect, these holographic optical elements may be positioned in a polymer. In another aspect, the holographic optical elements may be provided in or on a film, such as a PET film.

In a most basic case, the HOEs take the incoming light and redirect it. In a more complex case, the reflected light is also collimated by the HOE to modify the perceived virtual image distance perceived. In such cases, the HOE may either further collimate, to extend the virtual image distance, or reduce collimation, to shorten virtual image distance and broaden the eyebox viewing window. HOE films may be created with a range of specific reflection angles. In cases in which the incorporation of such films in laminated glass applications creates unwanted ghosting, the inventive aspects described below may be desirable.

It is understood, as known to those skilled in the art, that a single HOE film may be employed to modify light of more than one wavelength range, in a forming process referred to as multiplexing. It is also understood that multiple HOEs, each modifying light of a single wavelength range, or multiple wavelength ranges, may be combined to provide a similar effect.

The compound interlayers of the invention comprise a first wedge polymer layer, positioned on a first side of the reflective layer, so as to redirect visible light reflection from the reflective layer; and a second wedge polymer layer, positioned adjacent a second side of the reflective layer so as to redirect visible light reflection from an outer face of a glass lite when an inner face of the glass lite is placed adjacent the second wedge polymer layer.

As noted in U.S. Pat. No. 8,451,541, the relevant disclosure of which is incorporated herein by reference, double images that occur with head-up-displays (HUDs) can be particularly bothersome. With traditional HUDs, an image that contains important data for the driver is projected onto the windshield by an optical projection device arranged on the top of the dashboard on the driver's side. The image is reflected on the windshield to the driver who sees a virtual image that appears to be in front of the vehicle. However, the driver sees two separate images, i.e., one image that is produced by reflection on the inner surface of the windshield and an additional image, the so-called secondary or ghost image, that is produced by the reflection on the outer surface of the windshield.

As disclosed in U.S. Pat. Publn. No. 2017/0285339, the relevant disclosure of which is incorporated herein by reference, a method of reducing ghost images in windshields has been to orient the inner and outer glass panels at an angle from one another. This aligns the position of the reflected images to a single point, thereby creating a single image. Typically, this is done by displacing the outer panel relative to the inner panel by employing a single wedge-shaped, or “tapered,” interlayer that includes at least one region of nonuniform thickness. Most conventional tapered interlayers include a constant wedge angle over the entire HUD region, although some interlayers have recently been developed that include sections with multiple wedge angles, or sections with continuously varying wedge angles, over the HUD region. Traditional wedge interlayer design, however, only factors the correction needed to align the primary and secondary image reflections for the inner and outer surface reflections of a laminated glass windshield.

What is not accounted for when adding semitransparent films such as reflective layers to such a system, however, is the creation of a tertiary image from the additional reflection created by the embedded reflective film. Proper redirection of this tertiary image is not possible with existing wedge designs.

Thus, the compound interlayers of the invention are provided with what is described in certain of the claims as a first wedge polymer layer, positioned on a first side of the reflective layer, which redirects visible light reflection from the reflective layer so that it aligns with a primary image.

The invention further provides a second wedge polymer layer positioned adjacent a second side of the reflective layer so as to appropriately redirect visible light reflection from an outer face of a glass lite when an inner face of the glass lite is placed adjacent the second wedge polymer layer. The glass lite referred to may be, for example, the glass on the exterior of the vehicle, and the second wedge polymer layer thus redirects a secondary image so that it aligns with a primary image.

Thus, according to the present invention, the two wedge polymer layers together reduce or eliminate the visibility of both secondary or ghost images that arise from the exterior glass/air interface, as well as the tertiary visible light reflections that arise from the reflective layer of the invention, while providing, in one aspect, a heat-blocking windshield.

When practicing the invention, the effect of one wedge on the light passing through it inevitably affects the desired correction provided by the other wedge. That is, the size and shape of one wedge needed is in part a function of the size and shape of the other wedge. Thus, it is not sufficient to provide two wedge polymer layers of conventional design, that is, of the type designed to reduce or eliminate the visibility of secondary images that arise from the exterior glass/air interface. The effect of each wedge polymer layer on the other must be accounted for. Because of this, we have found it important that both the wedge angle variation as well as the waviness of each of the layers be well-controlled, as further described herein.

The first and second wedge polymer layers can be comprised of various polymers, but more typically a polymer such as PVB, as further described herein. Each wedge polymer layer of the compound interlayer may include one or more polymeric resins, optionally combined with one or more plasticizers, which have been formed into a sheet by any suitable method. One of more of the wedge polymer layers in the compound interlayer may further include additional additives, although these are not required. The polymeric resin or resins utilized to form an interlayer as described herein may comprise one or more thermoplastic polymer resins. When the interlayer includes more than one layer, each layer may be formed of the same, or of a different, type of polymer.

Examples of polymers suitable for forming the wedge polymer layers can include, but are not limited to, poly(vinyl acetal) polymers, polyurethanes (PU), poly(ethylene-co-vinyl) acetates (EVA), poly(vinyl chlorides) (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and ionomers thereof, derived from any of the previously-listed polymers, and combinations thereof. In some embodiments, the thermoplastic polymer can be selected from the group consisting of poly(vinyl acetal) resins, poly(vinyl chloride), poly(ethylene-co-vinyl) acetates, and polyurethanes, while in other embodiments, the polymer can comprise one or more poly(vinyl acetal) resins. Although generally described herein with respect to poly(vinyl acetal) resins, it should be understood that one or more of the above polymers could be included in addition to, or in the place of, the poly(vinyl acetal) resins described below in accordance with various embodiments of the present invention.

When the polymer used to form the wedge polymer layers includes a poly(vinyl acetal) resin, the poly(vinyl acetal) resin may include residues of any aldehyde and, in some embodiments, may include residues of at least one C₄ to C₈ aldehyde. Examples of suitable C₄ to C₈ aldehydes can include, for example, n-butyraldehyde, i-butyraldehyde, 2-methylvaleraldehyde, n-hexyl aldehyde, 2-ethylhexyl aldehyde, n-octyl aldehyde, and combinations thereof. In certain embodiments, the poly(vinyl acetal) resin may be a poly(vinyl butyral) (PVB) resin that primarily comprises residues of n-butyraldehyde. Examples of suitable types of poly(vinyl acetal) resins are described in detail in co-pending application Ser. No. 14/563,011 (now U.S. Publication No. 2016-0159041A1), the entirety of which is incorporated herein by reference to the extent not inconsistent with the present disclosure.

The present invention thus generally relates to compound interlayers, as well as laminated windshields employing such interlayers, that can be used in a vehicle having a head-up display (HUD) system. More specifically, compound interlayers and windshields as described herein may be configured to minimize, or even prevent, reflected image separation from the reflective layers and the outer glass surface.

Turning initially to FIG. 1, a schematic partial view of a vehicle 110 employing a HUD system 112 is shown. HUD system 112 includes a projection assembly 114, which is mounted below the vehicle dashboard 116 and is configured to project an image onto the vehicle windshield 120. As the image is projected from the projection assembly 114 onto the windshield 120, the collimated images reflected by the windshield 120 create a single virtual image 122 near the front of the vehicle 110. The virtual image can be projected such that it intersects the field of view 124 of the driver 126, thereby enabling the driver 126 to view the projected image 122 while simultaneously operating the vehicle 110.

The HUD system 112 can be any suitable type of system capable of projecting an image onto a vehicle windshield. In general, suitable HUD systems utilize a system of relay optics and the reflection of the windshield to create a virtual image 122 outside of the vehicle. The HUD system 112 can include a projection unit 111 configured to transmit an image amongst a plurality of mirrors, shown in FIG. 1 as 113a and 113b, and ultimately to pass the image to windshield 120. Generally, at least one of the mirrors is concave, as shown by mirror 113b in FIG. 1, in order to magnify the image for projection onto the windshield 120. The HUD system 112 may be configured in many different ways, and may be specifically designed for a certain vehicle according to vendor-specified installation conditions.

The windshield 120 is an integral optical component of the HUD system 112 and can act as the final optical combiner for reflecting the image into the driver's field of view 124. A windshield 220 configured according to embodiments of the present invention is illustrated in FIGS. 2a and 2b. Windshield 220 may comprise a pair of glazing panels 222a,b and a polymeric interlayer 224 disposed between and in contact with each of the panels 222a,b. Although shown in FIG. 2a for clarity in an exploded view, it should be understood that interlayer 224 may be in contact with a significant portion, or all, of the interior surfaces of each of panels 222a,b when assembled to form windshield 220.

Glazing panels 222a and 222b may be formed of any suitable material and can have dimensions required for any specific application. For example, in some embodiments, at least one of glazing panels 222a,b may be formed of a rigid material, such as glass, and each panels 222a,b may be formed from the same material or from different materials. In some embodiments, at least one of the panels 222a,b can be a glass panel, while, in other embodiments, at least one of the panels 222a,b can be formed of another material including, for example, a rigid polymer such as polycarbonate, acrylic, and combinations thereof. Typically, neither of the panels 222a,b is formed from softer polymeric materials including thermoplastic polymer materials more suitable for use in forming interlayer 224, as described in detail shortly.

In some embodiments, at least one of the panels 222a,b may comprise a glass panel. Any suitable type of glass may be used including, for example, a glass selected from the group consisting of alumina-silicate glass, borosilicate glass, quartz or fused silica glass, and soda lime glass. When used, the glass panel or panels may be annealed, thermally-treated, chemically-tempered, etched, coated, or strengthened by ion exchange, or one or both panels may have been subjected to one or more of these treatments. The glass itself may be rolled glass, float glass, or plate glass. In some embodiments, the glass may not be chemically-treated or strengthened by ion exchange, while, in other embodiments, the glass may not be an alumina-silicate glass. When both of panels 222a,b comprise glass panels, the type of glass used to form each may the same, or it may be different.

The panels 222a,b can have any suitable thickness. In some embodiments, the nominal thickness of the outboard panel 222b and/or inboard panel 222a can be at least about 0.4, at least about 0.5, at least about 0.6, at least about 0.7, at least about 0.8, at least about 0.9, at least about 1.0, at least about 1.1, at least about 1.2, at least about 1.3, at least about 1.4, at least about 1.5, at least about 1.6, at least about 1.7, at least about 1.8, at least about 1.9, at least about 2.0, at least about 2.1, at least about 2.2 millimeters (mm) and/or less than about 2.9 mm, less than about 2.8, less than about 2.7, less than about 2.6, less than about 2.5, less than about 2.4, less than about 2.3, less than about 2.2, less than about 2.1, less than about 2.0, less than about 1.9, less than about 1.8, less than about 1.7, less than about 1.6, less than about 1.5, less than about 1.4, less than about 1.3, less than about 1.2, less than about 1.1, or less than about 1.0 mm.

In certain embodiments, two panels 222a,b may have the same nominal thickness, which is typically referred to as a “symmetric” configuration, or one of the panels 222a,b may have thickness different than the other panel 222b,a. This is referred to as an “asymmetric” configuration. In certain embodiments when windshield 220 includes an asymmetric configuration, outboard panel 222b, which may be configured to face the outside of the vehicle, may have a greater thickness than inboard panel 222a, which may be configured to face toward the interior of the vehicle, when windshield 220 is installed in a vehicle. In certain embodiments, windshield 220 may have an asymmetric configuration in which inboard panel 222a has a greater thickness than outboard panel 222b.

As shown in FIG. 2a, inboard panel 222a, interlayer 224, and outboard panel 222b each include an upper installed edge, shown as 232a, 234a, and 236a, respectively, and a lower installed edge, shown as 232b, 234b, and 236b, respectively. Each of the upper and lower installed edges 232a,b, 234a,b and 236a,b of respective inboard panel 222a, interlayer 224, and outboard panel 222b can be spaced apart from each other in a generally vertical direction when windshield 120 is oriented in a manner similar to when it is installed in a vehicle.

Although terms such as “upper” and “lower” are relative, such terms, as used herein, are modified with “as installed” or “installed,” which refers to the relative position of a component or item when a windshield including the component or item is oriented as it would be when installed in a vehicle. Therefore, the “upper installed edge” and the “lower installed edge” respectively refer to the upper and lower edges of the windshield when the windshield 220 is oriented as it would be when installed in a vehicle. In some embodiments, one or more of upper installed edges 232a, 234a, and 236a of inboard panel 222a, interlayer 224, and outboard panel 222b can be within about 5°, within about 3°, or within about 1° of being parallel to its corresponding lower installed edges 232b, 234b, and 236b.

As shown in FIG. 2a, inboard panel 222a, interlayer 224, and outboard panel 222b each include a driver side installed edge 238a, 240a, and 242a, respectively, and a passenger side installed edge 238a, 240b, and 242b, respectively. The driver side installed edge of each of inboard panel 222a, interlayer 224, and outboard panel 222b can be spaced apart from the corresponding passenger side installed edge 238b, 240b, and 242b in a generally horizontal direction when the windshield 220 is oriented as it would be when installed in a vehicle. Although referred to herein as the “driver side” and the “passenger side,” it should be understood that the actual location of the driver and passenger may be reversed, depending on the country in which the vehicle employing the windshield is operated. These terms are used herein as a point of reference, and should not be construed as being unnecessarily limiting.

Additionally, as shown in FIG. 2a, each of driver side installed edges 238a, 240a, and 242a and passenger side installed edges 238b, 240b, and 242b of inboard panel 222a, interlayer 224, and outboard panel 222b intersect respective upper installed edges 232a, 234a, and 236a and lower installed edges 232b, 234b, and 236b at the corners of inboard panel 222a, interlayer 224, and outboard panel 222b, respectively. One or more of the driver side installed edges 238a, 240a, and 242a and/or one of the of one or more of the passenger side installed edges 238b, 240b, and 242b may be oriented at an angle with respect to the upper installed edges 232a, 234a, and 236a and/or lower installed edges 232b, 234b, and 236b of inboard panel 222a, interlayer 224, and outboard panel 222b. As a result, one or more of upper installed edges 232a, 234a, or 236a may be shorter than its corresponding lower installed edge 232b, 234b, or 236b. Additionally, although not depicted in FIG. 2a, the windshield may also be curved in one or more regions, and can, in some cases, have a complex curvature that changes in both the horizontal and vertical directions.

In certain embodiments, the length of at least one of upper installed edges 232a, 234a, and 236a of inboard panel 222a, interlayer 224, and outboard panel 222b may be at least about 500, at least about 650, at least about 750, at least about 850, at least about 950, at least about 1000 mm and/or not more than about 2500, not more than about 2000, not more than about 1500, not more than about 1250 mm, measured from the intersection of driver side installed edge 238a, 240a, or 242a with one end of upper installed edge 232a, 234a, or 236a to the intersection of passenger side edge 238b, 240b, or 242b with the other end of upper installed edge 232a, 234a, or 236a.

In certain embodiments, the length of at least one of lower installed edges 232b, 234b, and 236b of inboard panel 222a, interlayer 224, and outboard panel 222b may be at least about 750, at least about 900, at least about 1000, at least about 1250, or at least 1400 mm and/or not more than about 2500, not more than about 2250, not more than about 2000, not more than about 1850 mm, measured from the intersection of driver side installed edge 238a, 240a, or 242a with one end of lower installed edge 232b, 234b, or 236b to the intersection of passenger side edge 238b, 240b, or 242b with the other end of lower installed edge 232b, 234b, or 236b.

Further, in some embodiments, windshield 220 may have a curved lower region extending downwardly from lower installed edge 232b, 234b, and 236b of inboard panel 222a, interlayer 224, and outboard panel 222b. In such embodiments, the radius of curvature at the furthest point of the curved lower region from the lower installed edge 232b, 234b, or 236b can be at least 100, at least about 150, at least about 175, or at least about 200 mm and/or not more than about 325, not more than about 300, not more than about 275, not more than about 250, or not more than about 225 mm. However, exact dimensions may depend on the ultimate use of the windshield 220, and may vary outside the above ranges.

Referring now to FIGS. 2a and 2b, the compound interlayer or interlayer stack 224 may define a HUD region 244 that includes at least one region of nonuniform thickness. The interlayer 224 may be a composite interlayer, or interlayer stack, as illustrated in FIG. 2b, which shows a preferred application of the invention. When laminated between the intermediate film 224b and inboard panel 222a, the HUD region 244 of interlayer 224a may cause the intermediate film 224b to be oriented at a slight angle from the inboard panel 222a. Similarly, when laminated between outboard panel 222b and inboard panel 222a, the HUD region 244 of the combination of 224a, 224b, and 224c, may cause the outboard panel 222b to be oriented at a slight angle from the inboard panel 222a. The exact composition of the intermediate film 224b is unimportant, as long as it provides reflective properties. It should be noted that the exact angle of orientation depends on the sum of the individual wedge profiles of each component in the full interlayer stack 224, several embodiments of which will be discussed in detail shortly.

As shown in FIG. 2a, the HUD region 244 of interlayer stack 224 may be defined by an upper installed HUD boundary 246a and a lower installed HUD boundary 246b. As discussed previously, the upper and lower installed HUD boundaries 246a,b can be spaced from one another in a generally vertical direction when windshield 220 is oriented in a manner similar to when it is installed in a vehicle. Upper and lower installed HUD boundaries 246a,b can also be substantially parallel to respective upper and lower installed edges 234a,b of interlayer stack 224. As used herein the term “substantially parallel” means within about 5° of being parallel. In some embodiments, upper and lower installed HUD boundaries 246a,b can also be within about 3°, within about 2°, or within about 1° of being parallel to respective upper and lower installed edges 234a,b of interlayer 224 stack.

As shown in FIG. 2a, the lower HUD installed boundary 246b can be spaced from the lower installed edge 234b of interlayer stack 224 along the height of the windshield 220 when windshield 220 is oriented in a manner similar to when it is installed in a vehicle. As used herein, the term “height” refers to the second largest dimension of the windshield 220, when it is oriented as it would be when installed in a vehicle. The height of windshield 220 can be defined between, for example, upper and lower installed edges 232a,b, 234a,b, and 236a,b of inboard panel 222a, interlayer stack 224, and outboard panel 222b, respectively. Similarly, the “width” is the largest dimension of the windshield, and may be defined between the driver side and passenger side installed edges 238a,b, 240a,b, and 242a,b of inboard panel 222a, interlayer stack 224, and outboard panel 222b, respectively. Additionally, the “thickness” of the windshield 220 is the smallest dimension and may be the combined thicknesses of inboard panel 222a, interlayer stack 224, and outboard panel 222b, when each are laminated together to form windshield 220.

As shown in FIG. 2a, the lower HUD installed boundary 246a can be positioned between and may be generally parallel to upper installed edge 234a and lower installed edge 234b of interlayer stack 224. For example, lower HUD installed boundary 246a may be spaced from the lower installed edge 234b of interlayer stack 224 by a distance of at least about 150, at least about 200, at least about 225, at least about 250, at least about 275, at least about 300, or at least about 350 mm and/or not more than about 550, not more than about 500, not more than about 450, or not more than about 425 mm. The upper HUD installed boundary 246a and the upper installed edge 234a of the interlayer 224 can be spaced apart from each other, along the height of the interlayer 224, by at least about 125, at least about 150, at least about 175, at least about 200, at least about 225, at least about 250, at least about 275, or at least about 300 mm and/or not more than about 750 mm, not more than about 650 mm, not more than about 500 mm, not more than about 450 mm.

The total height of the HUD zone 244, measured between the upper and lower HUD installed boundaries 246a,b in a direction parallel to the height of the interlayer, can be at least about 20, at least about 25, at least about 50, at least about 75, at least about 100 mm and/or not more than about 350, not more than about 300, not more than about 250, not more than about 225, not more than about 200, not more than about 175, or not more than about 150 mm. The total height of the HUD zone 244 may be consistent along the width of the interlayer 224, or the height may be different in one or more regions of the HUD zone than it is in one or more other regions of the HUD zone. In some embodiments, at least about 15, at least about 20, at least about 25, at least about 30, at least about 35 and/or not more than about 55, not more than about 50, not more than about 45, or not more than about 40 percent of the total length of a line drawn between and perpendicular to each of the upper installed edge 234a and the lower installed edge 234b of the interlayer 224 may fall within the HUD region 244 of interlayer 224.

The HUD region 244 may extend across a portion, or all, of the total width of the interlayer 224. In some embodiments, the upper and/or lower HUD installed boundary may extend at least about 30, at least about 40, at least about 50, at least about 55, at least about 60, at least about 65, at least about 70, at least about 75, at least about 85, or at least about 90 percent of the total distance between the driver side installed edge 240a and the passenger side installed edge 240b of interlayer 224. In some embodiments, as shown in FIG. 2a, the HUD region 244 may extend across the entirety of the interlayer 224, such that upper HUD installed boundary 246a and lower HUD installed boundary 246b each intersect the driver side installed edge 240a and the passenger side installed edge 240b of interlayer 224, as shown in FIG. 2a.

It is understood that in the embodiment illustrated in FIG. 2b, one method of carrying out the invention would be to incorporate the two interlayers, 224a and 224c, with thickness profiles specifically designed to align the second and third reflections onto the primary reflection. It is further understood that a preferred way of accomplishing this may be to design a laminate with a symmetric thickness profile, centered around the reflective layer, such that the majority of the desired overlay effect can be generated by using the same wedge profiles for 224a and 224c, thus simplifying the interlayer and lamination manufacturing processes. In cases in which the glass or interlayer thicknesses have different thicknesses around the reflective layer, the interlayers will need to be designed with differing wedge angle profiles in order to properly align the secondary and tertiary images to the primary image.

It is understood that the modifications to interlayer wedge profiles made to improve optics in laminates containing single wedged interlayers will also apply to laminates containing multiple wedged interlayers. In such cases, each layer may have its own characteristic wedge profile for optimal use with HUD projection systems. Depending on the construction of the laminate and desired effect, each of the two wedged interlayers may be identical to the other, or different. Exemplary design approaches for each wedged interlayer may be found below.

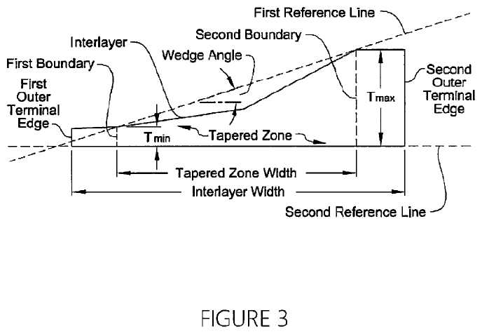

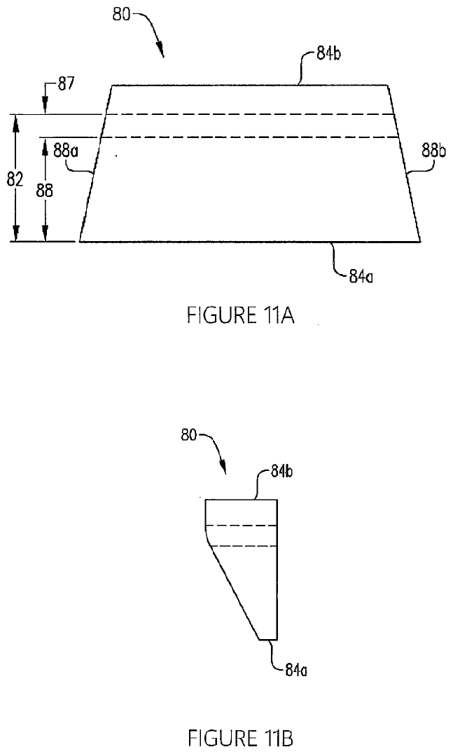

Turning to FIGS. 3 through 11b, several embodiments of interlayers having an at least partially tapered thickness profile and wedge angle profiles according to the present invention are provided. FIG. 3 is a cross-sectional view of an exemplary tapered interlayer that includes a tapered zone of varying thickness. As shown in FIG. 3, the tapered zone has a minimum thickness, Tₘᵢₙ, measured at a first boundary of the tapered zone and a maximum thickness, Tₘₐₓ, measured at a second boundary of the tapered zone. In certain embodiments, Tₘᵢₙ can be at least about 0.05, at least about 0.10, or at least about 0.20 mm and/or not more than 1.2, not more than about 1.1, or not more than about 1.0 mm. In certain embodiments, Tₘₐₓ can be at least about 0.38, at least about 0.53, or at least about 0.76 mm and/or not more than 2.2, not more than about 2.1, or not more than about 2.0 mm. In certain embodiments, the difference between Tₘₐₓ and Tₘᵢₙ can be at least about 0.05, at least about 0.10, at least about 0.15, at least about 0.20, at least about 0.25, at least about 0.30, at least about 0.35, at least about 0.40 mm and/or not more than 1.2, not more than about 0.90, not more than about 0.85, not more than about 0.80, not more than about 0.75, not more than about 0.70, not more than about 0.65, or not more than about 0.60 mm. In certain embodiments, the distance between the first and second boundaries of the tapered zone (i.e. the “tapered zone width”) can be at least about 5, at least about 10, at least about 15, at least about 20, or at least about 30 centimeters (cm) and/or not more than about 200, not more than about 150, not more than about 125, not more than about 100 or not more than about 75 cm.

As shown in FIG. 3, the tapered interlayer includes opposite first and second outer terminal edges. In certain embodiments, the distance between the first and second outer terminal edges (i.e., the “interlayer width”) can be at least about 20, at least about 40, or at least about 60 cm and/or not more than about 400, not more than about 200, or not more than about 100 cm. In the embodiment depicted in FIG. 3, the first and second boundaries of the tapered zone are spaced inwardly from the first and second outer terminal edges of the interlayer. In such embodiments, only a portion of the interlayer is tapered. When the tapered zone forms only a portion of the interlayer, the ratio of the interlayer width to the tapered zone width can be at least about 0.05:1, at least about 0.10:1, at least about 0.20:1, at least about 0.30:1, at least about 0.40:1 at least about 0.50:1, at least about 0.60:1, or at least about 0.70:1 and/or not more than about 1:1, not more than about 0.95:1, not more than about 0.90:1, not more than about 0.80:1, or not more than about 0.70:1. In an alternative embodiment, discussed below, the entire interlayer is tapered. When the entire interlayer is tapered, the tapered zone width can be equal to the interlayer width and the first and second boundaries of the tapered zone are located at the first and second terminal edges, respectively.

As illustrated in FIG. 3, the tapered zone of the interlayer can have a wedge angle (θ), which is defined as the angle formed between a first reference line extending through two points of the interlayer where the first and second tapered zone boundaries intersect a first (upper) surface of the interlayer and a second reference line extending through two points where the first and second tapered zone boundaries intersect a second (lower) surface of the interlayer. In certain embodiments, the tapered zone can have at least one wedge angle of at least about 0.05, at least about 0.10, at least about 0.15, at least about 0.20, at least about 0.25, at least about 0.30, at least about 0.35, or at least about 0.40 milliradians (mrad) and/or not more than about 1.2, not more than about 1.0, not more than about 0.90, not more than about 0.85, not more than about 0.80, not more than about 0.75, not more than about 0.70, not more than about 0.65, or not more than about 0.60 mrad.

When the first and second surfaces of the tapered zone are each planar, the wedge angle of the tapered zone can be defined as the angle between the first (upper) and second (lower) surfaces. However, as discussed in further detail below, in certain embodiments, the tapered zone can include at least one variable angle zone having a curved thickness profile and a continuously varying wedge angle. Further, in certain embodiments, the tapered zone can include two or more constant angle zones, where the constant angle zones each have a linear thickness profile, but at least two of the constant angle zones have different wedge angles.

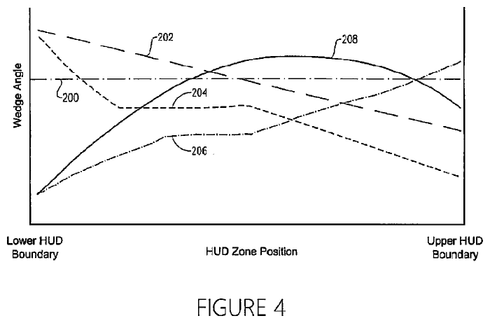

Referring now to FIG. 4, some exemplary wedge angle profiles for various tapered interlayers that may be suitable for use in certain embodiments of the present invention are shown. A wedge angle profile is a graphical depiction of the wedge angle of an interlayer as a function of position within the HUD region. The wedge angle profile of a tapered interlayer may increase, decrease, and/or remain constant over at least a portion of the HUD region. In certain embodiments, the wedge angle profile may increase over at least a portion of the HUD region. Examples of this type of wedge angle profile are shown by lines 206 and 208 in FIG. 4. When at least a portion of the wedge angle profile increases, at least a portion may also remain constant (as shown by line 206), or a portion of the profile may also decrease (as shown by line 208). In some embodiments (not shown), the wedge angle profile may increase over the entirety of the HUD region.

In certain embodiments, the wedge angle profile may decrease over at least a portion of the HUD region. Examples of this type of wedge angle profile are shown by lines 202 and 204 in FIG. 4. When at least a portion of the wedge angle profile of an interlayer decreases, the wedge angle profile may also increase (not shown) and/or remain constant (as shown by line 204) over a portion of the HUD region. In certain embodiments (shown by line 202), the wedge angle may decrease over the entirety of the HUD region. In certain embodiments, the wedge angle profile may remain constant over at least a portion of the HUD region, as shown by line 200 in FIG. 4. Interlayers having other combinations of regions of increasing, decreasing, and constant wedge angles are also possible and within the scope of the present invention.

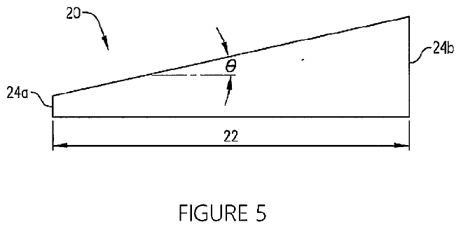

FIGS. 5 through 10 illustrate profiles of several tapered interlayers configured according to certain embodiments of the present invention. As discussed previously, the specific configuration of an interlayer for use in a given windshield utilized by a vehicle having a HUD projection system depends on several factors, including, for example, the specific vehicle design and the HUD system configuration. FIGS. 5 through 10 provide some exemplary tapered interlayer profiles that may be suitable for certain embodiments, although other interlayer shapes not shown may be equally suitable, depending on the specific application. It should be understood that the tapered thickness profiles and wedge angle profiles of the interlayers discussed herein refer to “vertical” profiles, taken along a line extending between the upper installed edge 234a and the lower installed edge 234b of the interlayer 224, unless otherwise noted. In certain embodiments, the interlayer 224 may not have a tapered thickness profile or a wedge angle profile in the horizontal direction (i.e., a horizontal thickness profile) within HUD region 244. In certain embodiments, the maximum horizontal wedge angle of the interlayer 224 may be less than 0.10, less than 0.075, less than 0.05, or less than 0.025 mrad.

Turning to FIG. 5, an interlayer 20 that includes a tapered zone 22 extending entirely from a first terminal edge 24a of the interlayer 20 to a second terminal edge 24b of the interlayer 20 is depicted. In this configuration, the first and second boundaries of the tapered zone are located at the first and second terminal edges 24a,b of the interlayer. The entire tapered zone 22 of the interlayer 20 depicted in FIG. 5 has a constant wedge angle θ that is simply the angle formed between the planar first (upper) and second (lower) planar surfaces of the interlayer 20.

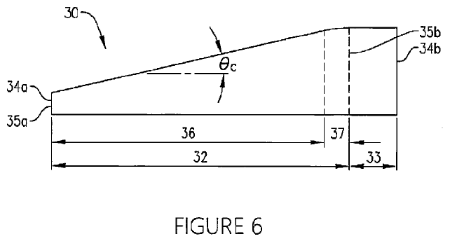

FIG. 6 illustrates an interlayer 30 that includes a tapered zone 32 and a flat edge zone 33. The first boundary 35a of the tapered zone 32 is located at the first terminal edge 34a of the interlayer 30, while the second boundary 35b of the tapered zone 32 is located where the tapered zone 32 and the flat edge zone 33 meet. The tapered zone 32 includes a constant angle zone 36 and a variable angle zone 37. The constant angle zone 36 has a linear thickness profile and a constant wedge angle, θ_{c}, while the variable angle zone 37 has a curved thickness profile and a continuously varying wedge angle. The starting wedge angle of the variable angle zone 37 is equal to the constant wedge angle θ_{c}, and the ending wedge angle of the variable angle zone 37 is zero. The interlayer 30 depicted in FIG. 6 has a constant wedge angle θ_{c}, that is greater than the overall wedge angle of the entire tapered zone 32.

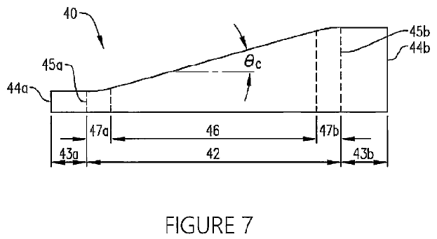

FIG. 7 illustrates an interlayer 40 that includes a tapered zone 42 located between first and second flat edge zones 43a,b. The first boundary 45a of the tapered zone 42 is located where the tapered zone 42 and the first flat edge zone 43a meet, while the second boundary 45b of the tapered zone 42 is located where the tapered zone 42 and the second flat edge zone 43b meet. The tapered zone 42 includes a constant angle zone 46 located between first and second variable angle zones 47a,b. The first variable angle zone 47a forms a transition zone between the first flat edge zone 43a and the constant angle zone 46. The second variable angle zone 47b forms a transition zone between the second flat edge zone 43b and the constant angle zone 46. The constant angle zone 46 has a linear thickness profile and a constant wedge angle, θc, while the first and second variable angle zones 47a,b have curved thickness profiles and continuously varying wedge angles. The starting wedge angle of the first variable angle zone 47a is equal to zero and the ending wedge angle of the first variable angle zone 47b is equal to the constant wedge angle θc, The starting wedge angle of the second variable angle zone 47b is equal to the constant wedge angle θc and the ending wedge angle of the second variable angle zone 47b is zero. The interlayer 40 depicted in FIG. 7 has a constant wedge angle θc, that is greater than the overall wedge angle of the entire tapered zone 42.

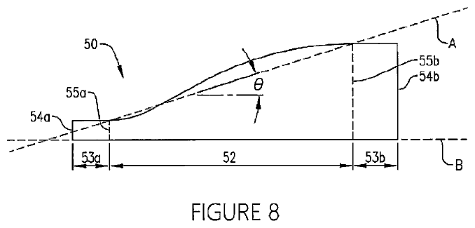

FIG. 8 illustrates an interlayer 50 that includes a tapered zone 52 located between first and second flat edge zones 53a,b. The tapered zone 52 of the interlayer 50 does not include a constant angle zone. Rather, the entire tapered zone 52 of the interlayer 50 is a variable angle zone having a curved thickness profile and a continuously varying wedge angle. As described above, the overall wedge angle, θ, of the tapered zone 52 is measured as the angle between a first reference line “A” extending through the two points where the first and second boundaries 55a,b of the tapered zone 52 meet the first (upper) surface of the interlayer 50 and a second reference line “B” extending through the two points where the first and second boundaries 55a,b of the tapered zone 52 meet the second (lower) surface of the interlayer 50. However, within the tapered zone 52, the curved thickness profile provides an infinite number of wedge angles, which can be greater than, less than, or equal to the overall wedge angle θ of the entire tapered zone 52.

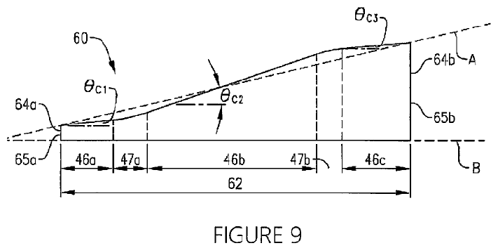

FIG. 9 illustrates an interlayer 60 that does not include any flat end portions. Rather, the tapered zone 62 of the interlayer 60 forms the entire interlayer 60. Thus, the first and second boundaries 65a,b of the tapered zone 60 are located at the first and second terminal edges 64a,b of the interlayer 60. The tapered zone 62 of the interlayer 60 includes first, second, and third constant angle zones 46a-c separated by first and second variable angle zones 47a,b. The first, second, and third constant angle zones 46a-c each have a linear thickness profile and each have unique first, second, and third constant wedge angles, θ_{c1}, θ_{c2}, θ_{c3}, respectively. The first variable angle zone 47a acts as a transition zone between the first and second constant angle zones 46a,b. The second variable angle zone 47b acts as a transition zone between the second and third constant angle zones 46b,c. As discussed above, the overall wedge angle, θ, of the tapered zone 62 is measured as the angle between a first reference line “A” and a second reference line “B.” The first constant wedge angle θ_{c1} is less than the overall wedge angle θ of the tapered zone 62. The second constant wedge angle θ_{c2} is greater than the overall wedge angle θ of the tapered zone 62. The third constant wedge θ_{c3} is less than the overall wedge angle θ of the tapered zone 62. The wedge angle of the first variable angle zone 47a continuously increases from the first constant wedge angle θ_{c1} to the second constant wedge angle, θ_{c2}. The wedge angle of the second variable angle zone 47b continuously decreases from the second constant wedge θ_{c2} to the third wedge angle θ_{c3}.

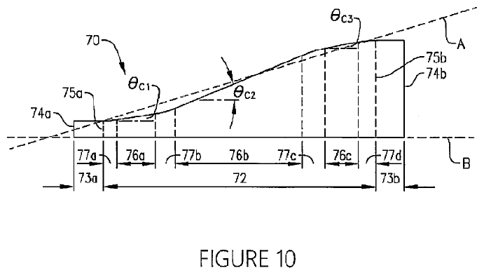

FIG. 10 illustrates an interlayer 70 that includes a tapered zone 72 located between first and second flat edge zones 73a,b. The first and second boundaries 75a,b of the tapered zone 72 are spaced inwardly from the first and second outer edges 74a,b of the interlayer 70. The tapered zone 72 of the interlayer 70 includes first, second, third, and fourth variable angle zones 77a-d and first, second, and third constant angle zones 76a-c. The first variable angle zone 77a acts as a transition zone between the first flat edge zone 73a and the first constant angle zone 76a. The second variable angle zone 77b acts as a transition zone between the first constant angle zone 76a and the second constant angle zone 76b. The third variable angle zone 77c acts as a transition zone between the second constant angle zone 76b and the third constant angle zone 76c. The fourth variable angle zone 77d acts as a transition zone between the third constant angle zone 76c and the second flat edge zone 73b. The first, second, and third constant angle zones 76a-c each have a linear thickness profile and each have unique first, second, and third constant wedge angles, θ_{c1}, θ_{c2}, θ_{c3}, respectively. As discussed above, the first, second, third, and fourth variable angle zones 77a-d have wedge angles that continuously transition from the wedge angle of the constant angle zone on one side of the variable angle zone 77 to the wedge angle of the constant angle zone on the other side of the variable angle zone 77.

As discussed above, the tapered interlayer can include one or more constant angle tapered zones, each having a width that is less than the overall width of the entire tapered zone. Each tapered zone can have a wedge angle that is the same as or different than the overall wedge angle of the entire tapered zone. For example, the tapered zone can include one, two, three, four, five or more constant angle tapered zones. When multiple constant angle tapered zones are employed, the constant angle tapered zones can be separated from one another by variable angle tapered zones that serve to transition between adjacent constant angle tapered zones.

In certain embodiments, the width of each constant angle tapered zone can be at least about 2, at least about 5, at least about 10, at least about 15, or at least about 20 cm and/or not more than about 150, not more than about 100, or not more than about 50 cm. In certain embodiments, the ratio of the width of each constant angle tapered zone to the overall width of the entire tapered zone can be at least about 0.1:1, at least about 0.2:1, at least about 0.3:1 or at least about 0.4:1 and/or not more than about 0.9:1, not more than about 0.8:1, not more than about 0.7:1, not more than about 0.6:1, or not more than about 0.5:1.

In certain embodiments, the wedge angle of each constant angle tapered zone can be at least about 0.13, at least about 0.15, at least about 0.20, at least about 0.25, at least about 0.30, at least about 0.35, at least about 0.40 mrad and/or not more than about 1.2, not more than about 1.0, not more than about 0.90, not more than about 0.85, not more than about 0.80, not more than about 0.75, not more than about 0.70, not more than about 0.65, or not more than about 0.60 mrad. In certain embodiments, the wedge angle of at least one constant angle tapered zone is at least about 0.01, at least about 0.05, at least about 0.10, at least about 0.20, at least about 0.30, or at least about 0.40 mrad greater than the overall wedge angle of the entire tapered zone.

In certain embodiments, the wedge angle of at least one constant angle tapered zone is at least about 0.01, at least about 0.05, at least about 0.10, at least about 0.20, at least about 0.30, or at least about 0.40 mrad less than the overall wedge angle of the entire tapered zone. In certain embodiments, the wedge angle of at least one constant angle tapered zone is not more than about 0.40, not more than about 0.30, not more than about 0.20, not more than about 0.10, not more than about 0.05, or not more than about 0.01 mrad greater than the overall wedge angle of the entire tapered zone. In certain embodiments, the wedge angle of at least one constant angle tapered zone is not more than about 0.40, not more than about 0.30, not more than about 0.20, not more than about 0.10, not more than about 0.05, or not more than about 0.01 mrad less than the overall wedge angle of the entire tapered zone.

In certain embodiments, the tapered interlayer can include at least one variable angle zone. The width of the variable angle zone may be less than the overall width of the entire tapered zone, or it may be the same as the tapered zone width. The width of each variable angle tapered zone can be at least about 2, at least about 5, at least about 10, at least about 15, or at least about 20 cm and/or not more than about 150, not more than about 100, or not more than about 50 cm. In certain embodiments, the ratio of the width of each variable angle tapered zone to the overall width of the entire tapered zone can be at least about 0.1:1, at least about 0.2:1, at least about 0.3:1 or at least about 0.4:1 and/or not more than about 0.9:1, not more than about 0.8:1, not more than about 0.7:1, not more than about 0.6:1, or not more than about 0.5:1. The variable angle zone may have a curved thickness profile and may, optionally, include one or more constant angle zones as described in detail previously. The interlayer may include at least two, at least three, or four or more variable angle zones.

In certain embodiments, one or both of the interlayers used to form a windshield as described herein may be a single layer, or monolithic, interlayer. In certain embodiments, at least one interlayer may be a multiple layer interlayer comprising at least a first polymer layer and a second polymer layer. When the interlayer is a multiple layer interlayer, it may also include a third polymer layer such that the second polymer layer is adjacent to and in contact with each of the first and third polymer layers, thereby sandwiching the second polymer layer between the first and third polymer layers. As used herein, the terms “first,” “second,” “third,” and the like are used to describe various elements, but such elements should not be unnecessarily limited by these terms. These terms are only used to distinguish one element from another and do not necessarily imply a specific order or even a specific element. For example, an element may be regarded as a “first” element in the description and a “second” element in the claims without being inconsistent. Consistency is maintained within the description and for each independent claim, but such nomenclature is not necessarily intended to be consistent therebetween. Three-layer interlayers may be described as having at least one inner “core” layer sandwiched between two outer “skin” layers. In certain embodiments, the interlayer may include more than three, more than four, or more than five polymer layers.

According to the invention, then, the compound interlayer includes a reflective layer that typically comprises a polymer film. This polymer film is present, in one aspect, in addition to the wedge polymer layers present in the compound interlayers. As used herein, the term “polymer film” refers to a relatively thin and often rigid polymer that imparts some sort of functionality or performance enhancement to the interlayer, in this case serving as a reflective layer as described elsewhere herein. The term “polymer film” is different than a “wedge polymer layer” or “wedge polymer sheet” as described herein, in that the polymer films do not themselves typically provide sufficient impact and glass retention properties to the panel, but, rather, provide performance improvements such as infrared absorption or reflection characteristics.

In certain embodiments, poly(ethylene terephthalate), or “PET,” may be used to form a polymer film and, ideally, the polymer films used in various embodiments are optically transparent. The polymer films suitable for use in certain embodiments may also be formed of other materials, including various metallic, metal oxide, or other non-metallic materials and may be coated or otherwise surface-treated, as described elsewhere herein. The polymer film may have a thickness of at least about 0.013, at least about 0.015, at least about 0.020, at least about 0.025, at least about 0.030, or at least about 0.040 mm and/or not more than about 0.060, not more than about 0.050, not more than about 0.045, or not more than about 0.035 mm.

According to some embodiments, the polymer film of the reflective layer may be a re-stretched thermoplastic film having specified properties, while, in other embodiments, the polymer film may include a plurality of nonmetallic layers that function to reflect infrared radiation without creating interference, as described, for example, in U.S. Pat. No. 6,797,396, which is incorporated herein by reference to the extent not inconsistent with the present disclosure. In certain embodiments, the polymer film may be surface treated or coated with a functional performance layer in order to improve one or more properties of the film, including adhesion or infrared radiation reflections. Other examples of polymer films are described in detail in PCT Application Publication No. WO88/01230 and U.S. Pat. Nos. 4,799,745, 4,017,661, and 4,786,783, each of which is incorporated herein by reference to the extent not inconsistent with the present disclosure. Other types of functional polymer films can include, but are not limited to, IR reducing layers, holographic layers, photochromic layers, electrochromic layers, anti-lacerative layers, heat strips, antennas, solar radiation blocking layers, decorative layers, and combinations thereof.

Additionally, at least one layer in the compound interlayers described herein may include one or more types of additives that can impart particular properties or features to the polymer layer or interlayer. Such additives can include, but are not limited to, dyes, pigments, stabilizers such as ultraviolet stabilizers, antioxidants, anti-blocking agents, flame retardants, IR absorbers or blockers such as indium tin oxide, antimony tin oxide, lanthanum hexaboride (LaB.sub.6) and cesium tungsten oxide, processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers. Additionally, various adhesion control agents (“ACAs”) can also be used in one or more polymer layers in order to control the adhesion of the layer or interlayer to a sheet of glass. Specific types and amounts of such additives may be selected based on the final properties or end use of a particular interlayer and may be employed to the extent that the additive or additives do not adversely affect the final properties of the interlayer or windshield utilizing the interlayer as configured for a particular application.

According to some embodiments, interlayers as described herein may be used to form windshields that exhibit desirable acoustic properties, as indicated by, for example, the reduction in the transmission of sound as it passes through (i.e., the sound transmission loss of) the laminated panel. In certain embodiments, windshields formed with interlayers as described herein may exhibit a sound transmission loss at the coincident frequency, measured according to ASTM E90 at 20° C., of at least about 34, at least about 34.5, at least about 35, at least about 35.5, at least about 36, at least about 36.5, or at least about 37 dB or more.

The overall average thickness of the compound interlayer can be at least about 10, at least about 15, at least about 20, at least about 25, at least about 30, or at least about 35 mils and/or not more than about 100, not more than about 90, not more than about 75, not more than about 60, not more than about 50, not more than about 45, not more than about 40, not more than about 35, not more than about 32 mils, although other thicknesses may be used as desired, depending on the particular use and properties of the windshield and interlayer. If the interlayer is not laminated between two substrates, its average thickness can be determined by directly measuring the thickness of the interlayer using a caliper, or other equivalent device. If the interlayer is laminated between two substrates, its thickness can be determined by subtracting the combined thickness of the substrates from the total thickness of the multiple layer panel.

Interlayers used to form windshields as described herein can be formed according to any suitable method. Exemplary methods of forming the wedge polymer layers can include, but are not limited to, solution casting, compression molding, injection molding, melt extrusion, melt blowing, and combinations thereof. Multilayer interlayers including two or more polymer layers may also be produced according to any suitable method such as, for example, co-extrusion, blown film, melt blowing, dip coating, solution coating, blade, paddle, air-knife, printing, powder coating, spray coating, lamination, and combinations thereof.

When the wedge polymer layers formed by an extrusion or co-extrusion process, one or more thermoplastic resins, plasticizers, and, optionally, one or more additives as described previously, can be pre-mixed and fed into an extrusion device. The extrusion device can be configured to impart a particular profile shape to the thermoplastic composition in order to create an extruded sheet. The extruded sheet, which is at an elevated temperature and highly viscous throughout, can then be cooled to form a polymeric sheet. Once the sheet has been cooled and set, it may be cut and rolled for subsequent storage, transportation, and/or use as an interlayer.

Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

In certain embodiments, the wedge polymer layers used to form the compound interlayers as described herein may be produced such that the wedge polymer layer has a wedge angle profile that deviates from a predetermined, or prescribed, wedge angle profile for a target interlayer by no more than 0.10, no more than 0.075, no more than 0.05 mrad, no more than 0.03, over at least about 50, at least about 60, at least about 70, at least about 80, or at least about 90 percent of the HUD region. In certain embodiments, the wedge angle profile of the wedge polymer layer may deviate from the predetermined wedge angle profile by no more than 0.10, no more than 0.075, no more than 0.05 mrad, no more than 0.03, over the entire region.

Methods of making such interlayers, or windshields including such interlayers, include the steps of obtaining prescribed wedge angle profiles for a target interlayer having a HUD region, and then forming an interlayer to have a similar wedge angle profile as the target interlayer. More particularly, the formation of the wedge polymer layer may be carried out such that the wedge angle profile varies from the prescribed wedge angle profile for the HUD region of the target interlayer by an amount within one or more of the above ranges. Such deviations can be determined by measuring the wedge angle of the formed interlayer, using, for example, a method as described in the Example below.

Alternatively, or in addition, the thickness profile of the wedge polymer layer may also be measured, and the measured thickness profile may be compared to a target thickness profile at one or more points along the layer. In certain embodiments, the maximum difference between the measured thickness profile of a layer formed as described herein, and a predetermined target thickness profile may be not more than about 0.005, not more than about 0.0025, not more than about 0.0020, not more than 0.0015, or not more than about 0.0010 mm. Alternatively, or in addition, the difference between the measured thickness profile of a layer formed as described herein, and a predetermined target thickness profile can be at least about 0.025, at least about 0.05, or at least about 0.10 percent and/or not more than about 0.25, not more than about 0.20, not more than about 0.15, not more than 0.1, or not more than about 0.05 percent, based on the target thickness at a given point.

The target wedge angle profile or target thickness profile may be provided by, for example, a third-party vendor, such as a laminator, a HUD system vendor, or a vehicle manufacturer, or it may be otherwise determined. In some embodiments, the measured wedge angle profile for a formed layer may vary slightly in shape from the target profile, but may still exhibit a maximum variation from the target wedge angle profile within the above ranges.

Windshields and other types of multiple layer panels may be formed from the compound interlayers and glazing panels as described herein by any suitable method. The typical glass lamination process comprises the following steps: (1) assembly of the two substrates and the interlayer; (2) heating the assembly via an IR radiant or convective device for a first, short period of time; (3) passing the assembly into a pressure nip roll for the first de-airing; (4) heating the assembly for a short period of time to about 60 .degree. C. to about 120 .degree. C. to give the assembly enough temporary adhesion to seal the edge of the interlayer; (5) passing the assembly into a second pressure nip roll to further seal the edge of the interlayer and allow further handling; and (6) autoclaving the assembly at temperature between 90 .degree. C. and 150 .degree. C. and pressures between 150 psig and 200 psig for about 30 to 90 minutes. Other methods for de-airing the interlayer-glass interface, as described according to one embodiment in steps (2) through (5) above include vacuum bag and vacuum ring processes, and both may also be used to form windshields and other multiple layer panels as described herein.

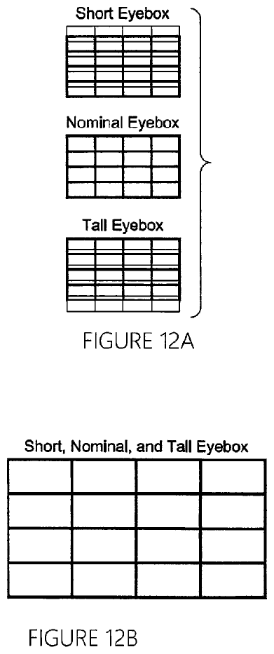

In one aspect, windshields configured according to certain embodiments of the present invention are designed to minimize reflected image separation for drivers of different heights. As used herein, the term “reflected double image separation” refers to the separation distance between the primary image and any interfering secondary, tertiary, or “ghost,” image that is caused by the differences in position of the projected image when it reflected. In contrast to conventional windshields, which are typically optimized to accommodate drivers of an average, or “nominal,” height, windshields of this aspect of the present invention may exhibit little or no double image separation for drivers shorter or taller than average or nominal. An example of the double image separation experienced by short and tall drivers, as compared to drivers of “nominal” height for conventionally optimized interlayers is provided in FIG. 12a. As shown in FIG. 12b, windshields configured according to embodiments of the present invention minimize reflected double image separation for all driver heights, providing a clearer, more readable virtual image at all heights.

In certain aspects, windshields configured as described herein may exhibit at least one of an upper eyebox reflected double image separation distance of less than about 2 arc-min and a lower eyebox reflected double image separation distance of less than about 2 arc-min, when measured at standard installation conditions for the particular windshield. As used herein, the term “eyebox” refers to a three-dimensional area in which the eye of the driver is positioned when the driver is seated in the vehicle in which the windshield and HUD projection system are installed. Typically, the eyebox is slightly larger than the eye itself to allow the driver some freedom of head movement, but does not extend more than 50 mm above or below, not more than 75 mm to the left or right, and not more than 50 mm in front of or behind the center point of the driver's eye when the driver is comfortably seated in the driver's seat. As used herein, the term “comfortably seated” means sitting with one's back against the driver's seat, one's foot on the pedals, and one's hands on the steering wheel.

In certain embodiments, windshields as described herein can have both an upper eyebox reflected double image separation distance of less than about 2 arc-min and a lower eyebox reflected double image separation distance of less than about 2 arc-min, when measured at standard installation conditions for that windshield. In certain embodiments, windshields may exhibit at least one of an upper eyebox reflected double image separation distance of less than about 1.75, less than about 1.5, less than about 1.25, less than about 1, or less than about 0.5 arc-min and/or a lower eyebox reflected double image separation distance of less than about 1.75, less than about 1.5, less than about 1.25, less than about 1, or less than about 0.5 arc-min, when measured at standard installation conditions for that windshield. The upper and lower eyebox reflected double image separation distances are determined according to the following procedure.

The standard installation conditions for a given windshield must be determined in order to measure the upper and lower eyebox reflected double image separation distances for that windshield. As used herein, the term “standard installation conditions” refer to the installation conditions for a given windshield under which a nominal height driver observes the minimum reflected double image separation distance for that windshield. In certain embodiments, the minimum reflected double image separation distance at standard installation conditions can be less than about 1.5, less than about 1, less than about 0.75, less than about 0.5, or less than about 0.25 arc-min, measured as described below. A “nominal height” driver is a driver whose eyebox centerline is at a height of 134.4 mm from a line drawn horizontally from the lower most point on the interior of the windshield, as installed. Further details about measuring driver height will be provided shortly.

If the standard installation conditions of a windshield, including how it is oriented with respect to a HUD projection system, are known, the windshield and HUD projection system may be arranged in an experimental set up according to the known installation conditions. Such installation conditions may be provided by a vendor, or another third party, may be directly measurable from a vehicle, or may be accessible in reference material related to the make and design of the vehicle.

Alternatively, if the standard installation conditions of the windshield are unknown, these must be determined before measuring the upper or lower eyebox reflected double image separation distances for that windshield. Such a determination can be made by, for example, testing various values for certain parameters of the windshield and HUD projection system and determining which combination of parameters provides the minimal reflected double image separation for a given windshield. The set of conditions optimized to provide the minimal reflected double image separation for the nominal driver height for a given windshield, would be considered the “standard installation conditions” for that windshield.

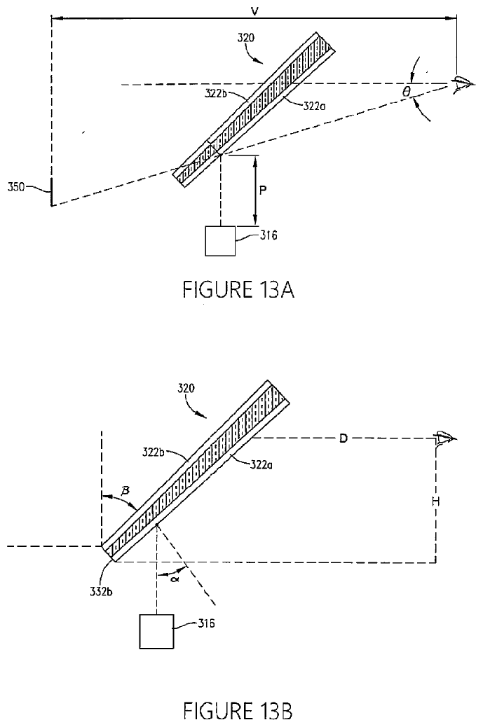

Referring now to FIGS. 13a and 13b, a schematic diagram of an experimental set up for testing the reflected double image separation distance of a windshield 320 is provided. Windshield 320 is positioned in a holder (not shown) and is oriented from the vertical at an angle, P, which is also referred to as the “rake angle” of the windshield. A suitable range of values for the rake angle is from 45 to 60°. As also shown in FIGS. 13a and 13b, the HUD projection system 316 is set up so that the image exiting the projection system 316 hits the inner surface of the inboard glass panel 322a as it would when the windshield and projection system were installed in a vehicle. The angle at which the projected image hits the surface of inner panel 322a is called the “angle of incidence” and the distance between the outlet of projection system 316 and the glass surface is called the “projection distance.” The angle of incidence, shown as angle α in FIG. 13b, is in the range of 30 to 45°, and the incident distance, shown as distance “P” in FIG. 13b, is between 5 and 20 cm. The virtual image distance is defined as the horizontal distance between the center point of the eye of the driver and the reflected virtual image 350. The virtual image distance is shown in FIG. 13b as distance “V,” and can be in the range of 3 to 15 m.

The height of the driver is defined as the vertical straight-line distance between a straight line extending horizontally from the lower installed edge 332b of the inner panel 322b and the center point of the eye of the driver. This is shown in FIG. 13a as distance “H.” When determining the standard installation conditions for a given windshield, the height of the driver, H, is set at 134.4 mm. The value of H varies to reflect changes in the height of the driver. The distance between the center point of the eye of the driver (or the center point of the driver's eyebox) and the surface of the inner panel 322a is defined as the “distance of driver.” This distance is shown as “D” in FIG. 13a and will vary with the height of the driver. For a driver of nominal height, the distance of driver, D, will range from 600 to 1000 mm. Similar values are expected for taller and shorter drivers. Finally, as shown in FIG. 13b, the look down angle is defined as the angle between a horizontal line drawn from the center point of the eyebox of the driver and a straight line drawn through the center of the HUD region of the windshield 320 and through the centerline of the reflected virtual image 350. Similar to driver distance, the look down angle, shown as θ in FIG. 13a, will vary based on the height of the driver, but should be in the range of 5° to 10°.

In order to determine the standard installation conditions for windshield 320, windshield 320 and HUD projection system 316 are arranged at various combinations of values for rake angle, angle of incidence, projection distance, and virtual image distance within the above ranges for a nominal driver height (H) of 134.4 mm. Then, for each set of conditions, the double image separation of the windshield can be determined, according to the method described in further detail below. The combination of values for rake angle, angle of incidence, projection distance, and virtual image distance that results in the lowest value for double image separation distance for a given windshield can be considered the “standard installation conditions” for that windshield.

Although the driver height and look down angle can be calculated for the nominal driver height, these parameters are not optimized, per se, when determining the standard installation conditions, as described above. Rather, the ranges for these values provided above are utilized as optimization limits, such that the final value for both the driver distance, D, and the look down angle, θ, calculated at the determined standard installation conditions must fall within the above ranges. Because the windshield 320 is oriented at an angle from the vertical, the driver distance, D, and look down angle, e, will change as the height of the driver changes, but should be within, or just outside of, the ranges provided above.

The double image separation distance of windshield 320 can be determined according to the following procedure. A projection image can be generated by passing light from the HUD projection system 316 through the windshield 320 when windshield 320 and projection system 316 are oriented as generally shown in FIGS. 13a and 13b. The light passing through the windshield 320 includes an image such as, for example, a line, a shape, a picture, or a grid. Once light has passed through and is reflected off the surfaces of the windshield 320, the virtual image can be viewed through the windshield 320. The projected image may be then captured using a digital camera or other suitable device, positioned with the center line of the camera lens positioned at the centerline of the eyebox. For determination of the standard windshield installation conditions, for example, the center line of the camera lens would be positioned at a height of 134.4 mm. The resulting image captured by the camera may then be digitized to form a digital projection image comprising a plurality of pixels.

Once digitized, captured images can be quantitatively analyzed to form a profile that includes at least one primary image indicator and at least one secondary image indicator. The analyzing may be performed by converting at least a portion of the digital projection image to a vertical image matrix that includes a numerical value representing the intensity of pixels in that portion of the image. A column of the matrix can then be extracted and graphed against pixel number, as shown in FIG. 14, to provide the profile. The primary image indicator on the profile can then be compared with the secondary image indicator on the profile to determine a difference. In some embodiments, the primary image indicator may comprise the higher intensity peaks of the graph, while the secondary image indicator may be the lower intensity peaks. Any suitable difference between the two indicators can be determined and, in some embodiments, can be the difference in position between the two indicators in the profile graph.

Based on the difference, the separation distance, in pixels, between the primary and secondary peaks can then be used to calculate the double image separation distance (D₁) for each panel, in milliradians (mrad), according to the following equation:

$${D}_{1} = 1000 \times \frac{peak separation ( pixels ) \times \frac{mm}{pixel}}{Virtual Image distance ( mm )}$$

The above equation is based on the small angle approximation, which, for a small angle θ, tan θ=θ, so that the double image separation distance (D₁) divided by the virtual image distance in mm is equal to the separation angle in radians. The ratio of mm/pixel may be determined by calculation from a calibration image. Next, with the windshield 320 and HUD projection system 316 positioned according to the standard installation conditions of the windshield, the height of the driver, H, is adjusted in order to measure the upper or lower eyebox reflected double image separation distance. When measuring the upper eyebox reflected double image separation distance, the centerline of the camera lens is moved to a height, H, of 182.4 mm and the lower eyebox reflected double image separation distance is measured with the centerline of the camera lens positioned at a driver height, H, of 126.2 mm. Once the camera is positioned, the driver distance, D, and look down angle, θ, can be calculated. Then the reflected double image separation distance can be determined for each height.

As discussed above, windshields configured according to embodiments of the present invention can have at least one of an upper eyebox reflected double image separation distance of less than about 2 arc-min and a lower eyebox reflected double image separation distance of less than about 2 arc-min, when measured at standard installation conditions for that windshield. This is an improvement over conventional windshields, which tend to minimize double image separation distance only for a single driver height, but produce significant ghosting for taller or shorter drivers.

Although described herein with respect to windshields for automobiles, it should be understood that multiple layer panels including interlayers as described herein may be used for a variety of applications, including as aircraft windshields and windows, as well as windshields and panels for other applications, including construction applications, marine applications, rail applications, motorcycle applications, and other recreational motor vehicles.

An alternate embodiment of this invention could be to utilize two wedged interlayers where the wedge angle of each PVB layer is exactly half of that required to align the primary and secondary images, and the individual PVB layer thicknesses are such that the metal stack of the XIR film is positioned precisely midway between surfaces #1 and #4. In this embodiment, the wedge angles of the two PVB layers are identical, but when the inner glass lite is thinner than the outer glass lite the PVB layer inboard of the XIR film will be thicker than the PVB layer outboard of the XIR film.

We have found, according to the invention, that the effect of one wedge on the light passing through it inevitably affects the desired correction provided by the other wedge. That is, the size and shape of one wedge needed is in part a function of the size and shape of the other wedge. It is not sufficient to provide two wedge polymer layers of conventional design, that is, of the type designed to reduce or eliminate the visibility of secondary images that arise from the exterior glass/air interface. The effect of each wedge polymer layer on the other must be accounted for. Because of this, we have found it important that the wedge angle variation of one or both wedges be well-controlled, as described herein.

We have also found that in practice, the thickness profiles of actual polymeric interlayer sheets which create the wedge angles intended to eliminate ghosting do not perfectly match the targeted thickness profiles calculated to eliminate ghost images. This results in real-world interlayers which contain small localized thickness deviations that result in similarly small localized wedge angle variations above and below the target wedge angle in the HUD zone, consisting of both positive and negative deviations. As a driver's head and eyes move within the HUD eyebox, the eyes view slightly different positions on the windshield in the HUD zone which have different localized wedge angles. This may result in different amounts of ghost image separation or ghosting. As previously stated, this change in the ghost image separation over short distances as the head and/or eye position moves is referred to as “dynamic ghosting”.

To quantify and limit the amount of dynamic ghosting that a driver experiences, it is thus helpful to define the absolute magnitude and the rate of change of the wedge angle variation from the target wedge angle which eliminates ghosting over a typical viewing distance as seen from the driver's eyebox. If the rate of change of the wedge angle variation is too great, the dynamic ghosting will be objectionable. In embodiments, the absolute wedge angle variation from target is less than 0.1 mrad and the 50 mm rate of change of the wedge angle is less than 4 μrad per millimeter (that is, from −4 μrad/mm to +4 μrad/mm), less than 3, less than 2, or less than 1 μrad/mm (−1 μrad/mm to +1 μrad/mm).

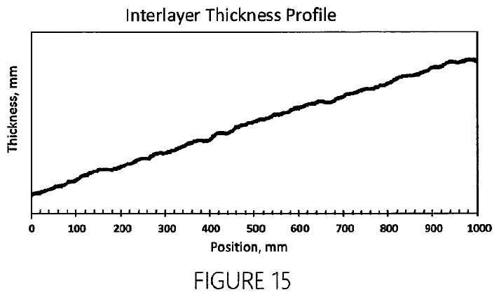

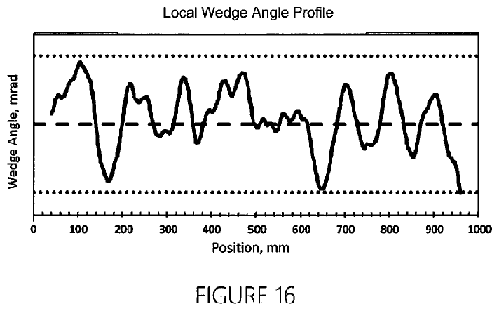

FIG. 15 depicts a thickness profile of an actual wedge interlayer for use in the windscreen of a HUD system. FIG. 16 depicts the plot of the actual local wedge angle variation from target of the wedge interlayer of FIG. 15. On the Y axis, the deviation from target is plotted, and the ideal case of 0.00 mrad deviation (no variation) is shown on FIG. 16 as a dashed line conforming to the equation y=theta, where theta is the target wedge angle. The curve shows how the actual wedge angle of a typical wedged interlayer varies above and below the target wedge angle over a distance of approximately 900 millimeters.

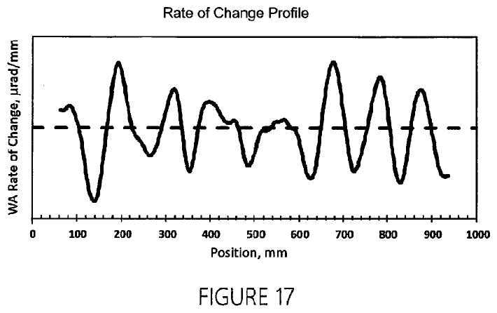

FIG. 17 is a plot of the rate-of-change of the local wedge angle deviation of the wedge interlayer depicted in FIG. 16. To calculate the rate of change, a point-by-point linear regression slope over a 50 mm span (+/−25 mm from each point) is calculated from the local wedge angle data plotted in FIG. 6 and plotted against the same positional axis. A 50 mm span is chosen as it generally corresponds with a typical range of motion that may occur by a viewer of the head-up display within a typical HUD eyebox region. On the Y axis, the rate of change of the local wedge angle deviation is plotted, and the ideal case of 0.0 mrad/mm is shown as a dashed line conforming to the equation y=0. The curve shows how the actual wedge angle rate of change of a typical wedged interlayer varies above and below zero over a distance of approximately 900 millimeters. In embodiments, the rate of change should be less than 4 μrad/mm, less than 3.5, 3.0, 2.5, 2.0, 1.5, 1.0 or less than 0.5 μrad/mm, or as close to 0.0 μrad/mm as possible.

As noted, the effect of one wedge on the light passing through it inevitably affects the subsequent correction provided by the other wedge. Because of this, we have found it important that the waviness of each of the layers be well-controlled.

Thus, in addition to using two wedged interlayers to align the tertiary image with the primary and secondary images, utilizing PVB wedged interlayers with a “low waviness” surface topography can further improve the tertiary image by reducing the waviness, or undulation, of that image. “Low waviness” interlayers are disclosed and claimed in U.S. Provisional Application No. 62/706,067, the disclosure of which is incorporated herein by reference in its entirety, for use in reducing applesauce appearance with XIR films. The present invention, in one aspect, thus relates to the combination of low waviness interlayers and two wedged interlayers to both flatten and align the tertiary image in HUD systems.

In practice, thickness profiles and surface characteristics of actual polymeric interlayer sheets can also negatively affect windshield optics beyond the effectiveness of head up display systems. Defects known as applesauce will also occur in multiple layer glass panels that incorporate polyvinyl acetal sheets disposed in contact with reflective polymer film layers. Polymer sheets with a low waviness index, or WI, which is a measure of the undulations of the surface of the sheet, and a high roughness value, or Rz, which is a measure of the smaller irregularities that occur, can help reduce or eliminate such defects.

Applesauce defects can be particularly noticeable at oblique viewing angles, and occur in safety glass panels as a visually apparent, isotropic, wave-like reflected image estimated to have an amplitude of about 0.002 to 0.012 mm and a wavelength of 2.5-7.5 mm. It is referred to hereinafter by the term “applesauce.” Applesauce is believed to occur because the reflective layer, which reflects light at oblique viewing angles, conforms to the polyvinyl acetal-type layer during lamination and will assume any non-linearity, or waviness, that is present on that polyvinyl acetal-type layer. This is especially true for polyvinyl acetal layers that have been embossed with surface topographies following extrusion.

In some aspects of the embodiments, polyvinyl acetal layers with relatively smooth surface or surfaces is/are embossed with a roughness pattern. This roughness pattern can be any suitable pattern, and, in various embodiments, results in a polymer sheet having a final roughness value (post-embossing value) of at least 20 micrometers, at least 25 micrometers, at least 30 micrometers, at least 35 micrometers, at least 45 micrometers, or at least 55 micrometers. Because this embossing step is carried out prior to lamination of the layer with poly(ethylene terephthalate), or glass, or another layer of poly(vinyl butyral), the embossed surfaces allow for superior deairing between the layers of the final product.

Applesauce defects can be significantly reduced through the use of polymer sheets having one or both surfaces with an advantageously low waviness index and a relatively high roughness value. Specifically, in various embodiments of the present invention, a wedged polymer sheet, after embossing with a roughness pattern, may have a waviness index of less than 20,000 square micrometers, less than 15,000 square micrometers, less than 12,000 square micrometers, less than 10,000 square micrometers, less than 8,000 square micrometers, less than 6,000 square micrometers, or less than 5,000 square micrometers, and a roughness value of at least 20 micrometers, at least 25 micrometers, at least 30 micrometers, at least 35 micrometers, at least 45 micrometers, or at least 55 micrometers, and the values given above for waviness index and roughness value can be combined in any combination, where appropriate. The values given in this paragraph are the “post-embossing” values of waviness and roughness. For these and other embodiments of the present invention in which both a WI and a roughness value are given, corresponding further embodiments are also part of the present invention where only the roughness values given, and not the WI, are used to characterize the polymer sheet.

In addition to the WI and roughness values, polymer sheets of the present invention are also characterized by their permanence, which is a measure of the alterability of the fine surface topography of the sheet. Determination of permanence for one or both surfaces of polymer sheet can be determined according to the procedure described below.

Polymer sheets of the present invention that are produced with low roughness and waviness and are embossed to a high roughness value may have permanence values that range from 95 down to 10. This range contrasts with polymer sheets that rely solely on melt fracture to obtain surface roughness, which generally have permanence values at 100 or close to 100. The value of the permanence that is imparted to a polymer sheet will depend on the desired application and lamination processing conditions that may be employed. For applications in which it is desirable to maximally reduce applesauce, for example, polymer sheets of the present invention may have permanence values of less than 40, less than 30, or less than 20, which is not to say that applesauce is not reduced in other embodiments having higher permanence values. In other embodiments in which a specific reduction of other defects is desirable, permanence values of from 60 to 95, 65 to 90, or 70 to 80 may be imparted to the polymer sheet. Other permanence values that are useful in various embodiments of the present invention are 10 to 30, 30 to 50 and from 50 to 95, 50 to 90, or 50 to 85. These permanence values given in this paragraph may be combined with the post embossing roughness and waviness values given above in any combination. Methodologies for the characterization of waviness, surface topography, and permanence is described in the paragraphs below.

To determine Rz, a 15 cm by 15 cm test sample of plasticized polymer sheet is placed on a vacuum plate regulated by fluid at room temperature circulating through it. A vacuum of 5 psi is imposed to draw the sample against the plate surface. A model S8P Perthometer with a PRK drive unit and an RFHTB-250 tracing stylus (available from Mahr Gage Co., New York) is used to directly measure sheet surface roughness of each side of the test sample. Profile selection is set to “R” on the instrument. The tracing stylus moves automatically across the sample surface. The length of each trace is 17.5 mm composed of 7 sequential measuring lengths Lc of 2.5 mm. The measuring length is 12.5 mm and is composed of the 5 measuring lengths obtained by eliminating the first and the last sections. The average value of individual roughness depths in these five sequential measuring lengths Lc is determined and Rz is the average of ten such determinations, five taken in the machine direction of extrusion (MD) and five in the cross-machine direction (CMD). The distance between two consecutive traces in each direction is 3 mm.

To determine a waviness index value (WI), the Perthometer referred to above is used with the profile selection set to “W”. A tracing length of 56 mm and a measuring length of 40 mm are used for this measurement. The 40 mm measuring length is composed of five 8 mm measuring lengths (the two end 8 mm measuring lengths are eliminated). Using a digital output from a plug connection in the back of the Perthometer, the variable waviness output voltage signal from the Perthometer is electronically fed to a computer. Ten traces are performed, with five traces taken in the machine direction of extrusion and five traces in the cross-machine direction with a distance of 3 mm between two consecutive traces. The program Sub SmoothData( ) computes a single WI value from the input of the ten traces.

The WI value of the surface of a sheet of polymer, for example from a sheet that is sized for use in a car windshield, is then computed by averaging 100 single WI values from evenly distributed sampling points throughout the surface of the sheet.

The same calculations can be performed on the opposite surface, and, as indicated elsewhere, can yield similar or different results, depending on the method of manufacture and the desired product. In various embodiments of the present invention, at least 90 of the 100 values obtained fall within +/−20% of the average of the 100 values, +/−15% of the average, +/−10% of the average, +/−5% of the average, or +/−2% of the average of the 100 values. Unless otherwise indicated in a claim, when a “WI value” for a polymer sheet surface is given in a claim, at least 90 of the 100 values obtained in the measurement process described above fall within +/−20% of the average of the 100 values.

Using the above-noted Perthometer, other set-up switch positions for roughness are as follows: Filter: GS, Profile: R, LC: N 2.5 mm, LT: 17.5 mm, VB: 625 micrometers. For waviness the set-ups are as follows Filter: GS, Profile: W, LC: N 8.0 mm, LT: 56 mm, VB: 625 micrometers.

Polymer sheets may also be characterized by their “permanence,” which is determined according to the following technique: For polymer sheets that are embossed, a polymer sheet is measured for Rz (Rz Base) prior to embossing. After embossing, a second Rz measurement is taken (Rz Final). For polymer sheets that are not embossed a roughness measurement, Rz, is taken and designated Rz Final, and Rz Base is given the value zero. For both embossed and non-embossed sheets, a 12.7 centimeter square sample is then cut from the polymer sheet. A 14 centimeter square piece of poly(ethylene terephthalate) is placed on a wood frame resting on a horizontal surface, wherein the frame periphery is slightly smaller than the polymer sheet sample. The polymer sheet sample is then placed on the poly(ethylene terephthalate) film, and then another section of poly(ethylene terephthalate) film is placed over the polymer sheet. A second frame is then placed on top of the polymer layers. The frames are then clamped together with binder clips. The frame and polymer assembly is then placed in a preheated oven for 5 minutes at 100° C. The assembly is then removed and allowed to cool. Another Rz value is then determined for the polymer sheet sample (Rz 100° C.).

Permanence can then be determined according to the following formula:

$$Permanence = [ \frac{( Rz 100 ° C . ) - ( Rz Base )}{( Rz Final ) - ( Rz Base )} ] \times 100$$

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are intended to be reported precisely in view of methods of measurement. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the denomination of process steps, ingredients, or other aspects of the information disclosed or claimed in the application with letters, numbers, or the like is a convenient means for identifying discrete activities or ingredients and the recited lettering can be arranged in any sequence, unless otherwise indicated.

As used herein, the singular forms “a”, “an”, and “the” include plural referents unless the context clearly dictates otherwise. For example, reference to a Cn alcohol equivalent is intended to include multiple types of Cn alcohol equivalents. Thus, even use of language such as “at least one” or “at least some” in one location is not intended to imply that other uses of “a”, “an”, and “the” excludes plural referents unless the context clearly dictates otherwise. Similarly, use of the language such as “at least some” in one location is not intended to imply that the absence of such language in other places implies that “all” is intended, unless the context clearly dictates otherwise.

As used herein the term “and/or”, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

This invention can be further illustrated by the following examples of embodiments thereof, although it will be understood that these examples are included merely for purposes of illustration and are not intended to limit the scope of the invention unless otherwise specifically indicated.

The following example is intended to be illustrative of the present invention in order to teach one of ordinary skill in the art to make and use the invention and is not intended to unnecessarily limit the scope of the invention in any way.

### Examples

The working examples consist of laminates prepared with specific interlayers or multiple layer interlayers. The standard glass lamination process used comprises the following steps: (1) assembly of two 2.3 mm glass substrates and interlayer or interlayers; (2) insertion of the laminate assembly into a vacuum bag which is then evacuated to −29 mm Hg and held for 20 minutes at room temperature to partially deair the assembly; (3) placing the vacuum bag and laminate assembly in a convection oven at 90° C. for 30 minutes to complete the deair and partially bond the assembly; (4) removing the laminate assembly from the vacuum bag: and (5) autoclaving the laminate assembly at standard conditions used to complete the bonding of the assembly in order to produce automotive glazings, particularly employing autoclave hold conditions of 143° C. and 13 bar for a period of 20 minutes.

After lamination, each finished assembly was evaluated by first projecting onto each laminate a HUD image defined by a horizontal line pattern with a 4.2 meter virtual image distance. The resulting image reflected off each laminate was captured using a 20 MP machine vision camera. Each image was then subsequently analyzed by plotting the pixel intensity in a vertical line selected in a region representative of the average image appearance. From this plot, peak positions were determined, representing the ghost image separation distance in pixels. Image separation was converted to a separation in millimeters by way of a calibration image, and subsequently into an angular separation (in radians) according to the following formula:

$$Angular Separation = {tan}^{- 1} ( \frac{mm separation}{virtual image distance} )$$

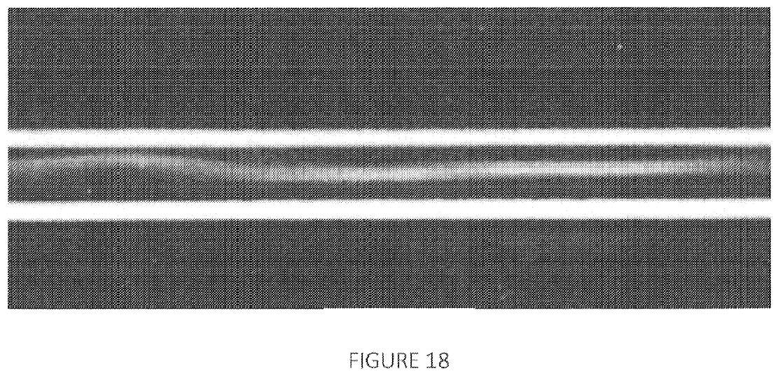

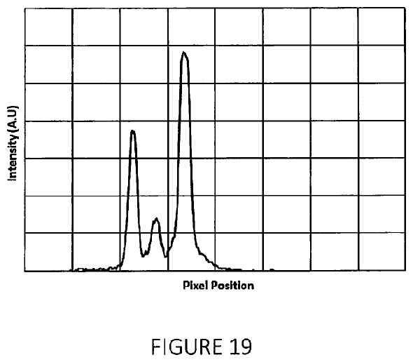

FIG. 18 shows an example of an image captured off of a non-wedge laminate containing a metalized IR reflective film. Three distinct lines can be observed representing (from top to bottom) the line image reflected off the outer glass surface, the metallized film surface, and the inner glass surface. FIG. 19 shows the corresponding plot of pixel intensity of a vertical line trace running through the approximate center of the image.

### Comparative Example 1

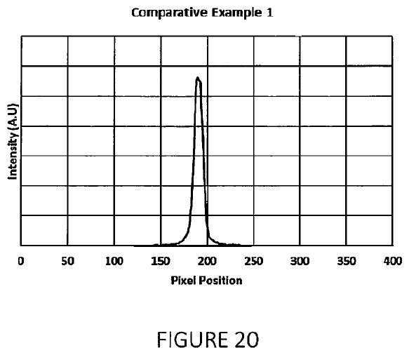

A laminate containing two pieces of 2.3 mm glass and a single wedge PVB interlayer with a 0.40 mrad wedge angle was prepared and analyzed as described above. Upon inspection of the HUD line image a single line is observed with no ghost image (FIG. 20).

### Comparative Example 2

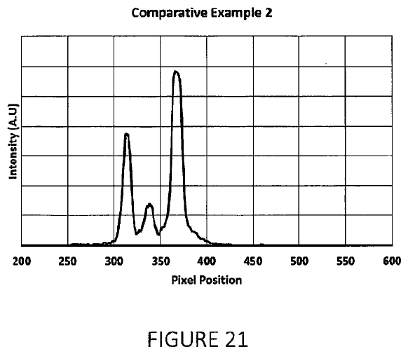

A laminate containing two pieces of 2.3 mm glass and a non-wedge multiple layer interlayer consisting of 0.38 mm PVB/XIR film/0.38 mm PVB was prepared and analyzed as described above. Upon inspection of the HUD line image three lines are observed (FIG. 21). The secondary image (reflected off the outer glass surface) has a ghost image separation of 2.8 mrad above the primary image, and the tertiary image (reflected off the metallized film layer) has a ghost image separation of 1.5 mrad above the primary image.

### Comparative Example 3

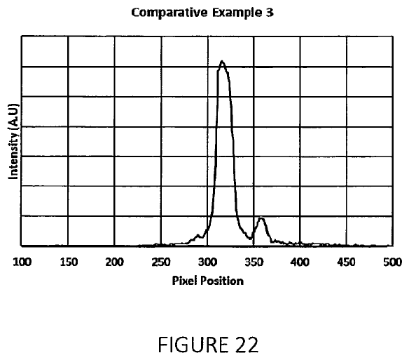

A laminate containing two pieces of 2.3 mm glass and a multiple layer interlayer consisting of 0.38 mm PVB/XIR film/0.4 mrad wedge PVB was prepared and analyzed as described above. Upon inspection of the HUD line image two lines are observed (FIG. 22). The secondary image (reflected off the outer glass surface) is aligned with the primary image and therefore not separately observable, and the tertiary image (reflected off the metallized film layer) has a ghost image separation of 2.2 mrad below the primary image.

### Comparative Example 4

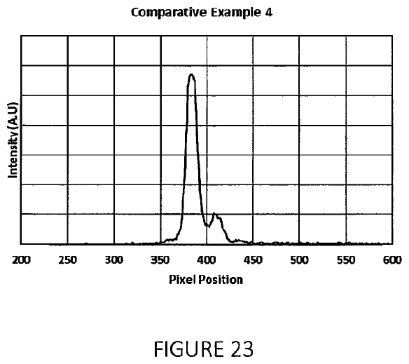

A laminate containing two pieces of 2.3 mm glass and a multiple layer interlayer consisting of PVX film (containing a PVB layer and a reflective layer)/0.4 mrad wedge PVB was prepared and analyzed as described above. Upon inspection of the HUD line image two lines are observed (FIG. 23). The secondary image (reflected off the outer glass surface) is aligned with the primary image and therefore not separately observable, and the tertiary image (reflected off the metallized film layer) has a ghost image separation of 1.3 mrad below the primary image.

### Example 1 (Working Example)

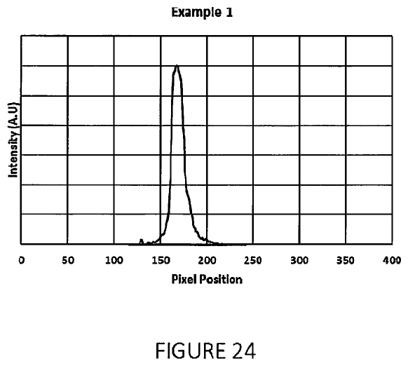

A laminate containing two pieces of 2.3 mm glass and a multiple layer interlayer consisting of 0.2 mrad trilayer wedge PVB/XIR film/0.2 mrad trilayer wedge PVB was prepared and analyzed as described above. Upon inspection of the HUD line image a single line is observed with no ghost image (FIG. 24), indicating that both the secondary image (reflected off the outer glass surface) and the tertiary image (reflected off the metallized film layer) are aligned with the primary image and therefore not separately observable.

### Example 2. (Prophetic)

A laminate containing two pieces of 2.3 mm glass and a multiple layer interlayer consisting of 0.2 mrad trilayer wedge PVB/XIR film/0.2 mrad wedge PVB is prepared and analyzed. Upon inspection of the HUD line image a single line is observed with no ghost image indicating that both the secondary image (reflected off the outer glass surface) and the tertiary image (reflected off the HOE film layer) are aligned with the primary image and therefore not separately observable.

### Example 3. (Prophetic)

A laminate containing two pieces of 2.3 mm glass and a multiple layer interlayer consisting of 0.2 mrad trilayer wedge PVB/HOE film/0.2 mrad wedge PVB is prepared and analyzed. Upon inspection of the HUD line image a single line is observed with no ghost image indicating that both the secondary image (reflected off the outer glass surface) and the tertiary image (reflected off the HOE film layer) are aligned with the primary image and therefore not separately observable.

### Example 4. (Prophetic)

A laminate containing two pieces of 2.3 mm glass and a multiple layer interlayer consisting of 0.2 mrad trilayer wedge PVB/3M™ Infrared Reflecting multi-layer optical film reflects/0.2 mrad wedge PVB is prepared and analyzed. Upon inspection of the HUD line image a single line is observed with no ghost image indicating that both the secondary image (reflected off the outer glass surface) and the tertiary image (reflected off the HOE film layer) are aligned with the primary image and therefore not separately observable.

### Example 5. (Prophetic)

A laminate containing two pieces of 2.3 mm glass and a multiple layer interlayer consisting of 0.2 mrad wedge TPU/XIR film/0.2 mrad wedge TPU is prepared and analyzed. Upon inspection of the HUD line image a single line is observed with no ghost image indicating that both the secondary image (reflected off the outer glass surface) and the tertiary image (reflected off the HOE film layer) are aligned with the primary image and therefore not separately observable.

| | Image Separation Relative to the Primary | |
|---|---|---|
| | Image (mrad) | |
| | Secondary Image | Tertiary Image |
| Comparative Example 1 | 0 | n/a |
| Comparative Example 2 | 2.8 | 1.5 |
| Comparative Example 3 | 0 | −2.2 |
| Comparative Example 4 | 0 | −1.3 |
| Example 1 | 0 | 0 |
| Example 2 | 0 | 0 |
| Example 3 | 0 | 0 |
| Example 4 | 0 | 0 |
| Example 5 | 0 | 0 |

1. A windshield having an optical path, comprising:
a. an inner rigid substrate, optically adjacent a first wedge polymer layer, that serves to reflect a primary image;
b. a reflective layer, positioned in the optical path between the first wedge polymer layer and a second wedge polymer layer; and
c. an outer rigid substrate, optically adjacent the second wedge polymer layer,
wherein the first wedge polymer layer causes visible light reflected from the reflective layer to overlap the primary image, and
wherein the second wedge polymer layer causes visible light reflected from an outer face of the outer rigid substrate to overlap the primary image.

2. The windshield of claim 1, wherein the visible light reflected from the reflective layer and the visible light reflected from the outer face of the outer rigid substrate each overlap the primary image with an image separation distance of less than about 1.5 arc-min.

3. The windshield of claim 1, wherein at least one of the first wedge polymer layer and the second wedge polymer layer has a surface with a waviness index of less than 20,000 square micrometers, an Rz value of at least 20 micrometers, and a permanence of between 10 and 95.

4. The windshield of claim 1, wherein at least one of the first wedge polymer layer and the second wedge polymer layer has an absolute wedge angle variation from target that is less than 0.1 mrad and the 50 mm rate of change of the wedge angle is less than 4 μrad per millimeter.

5. The windshield of claim 1, wherein the reflective layer selectively reflects infrared light.

6. The windshield of claim 1, wherein the first wedge polymer layer and the second wedge polymer layer comprise poly(vinyl acetal).

7. The windshield of claim 1, wherein the first wedge polymer layer and the second wedge polymer layer have a thickness from about 0.05 mm to about 1.2 mm.

8. The windshield of claim 1, wherein the first wedge polymer layer and the second wedge polymer layer have a thickness from 0.1 mm to 1.0 mm.

9. The windshield of claim 1, wherein the first wedge polymer layer and the second wedge polymer layer comprise poly(vinyl acetal) and have the same thickness.

10. The windshield of claim 1, wherein the first wedge polymer layer and the second wedge polymer layer are positioned as mirror images of one another.

11. The windshield of claim 1, wherein at least one of the first wedge polymer layer and the second wedge polymer layer comprise at least one skin layer and at least one core layer.

12. The windshield of claim 1, wherein one of the wedge polymer layers comprises:
a. at least a first layer comprising a first poly(vinyl acetal) resin having a first residual hydroxyl content and a first residual acetate content, and a first plasticizer, wherein the first layer has a glass transition temperature (T_{g}) greater than 26° C.; and
b. a second layer comprising a second poly(vinyl acetal) resin having a second residual hydroxyl content, and a second plasticizer, wherein the second layer has a glass transition temperature (T_{g}) less than 20° C.

13. The windshield of claim 1, wherein at least one of the first wedge polymer layer and the second wedge polymer layer comprises at least one skin layer and at least one core layer and has a thickness from about 0.1 mm to about 1.0 mm.

14. The windshield of claim 1, wherein at least one of the first wedge polymer layer and the second wedge polymer layer does not comprise at least one skin layer and at least one core layer, and has a thickness from about 0.1 mm to about 1.0 mm.

15. The compound interlayer of claim 1, wherein the reflective layer comprises a holographic optical element.

16. The compound interlayer of claim 1, wherein the reflective layer comprises a metallized film.

17. The compound interlayer of claim 1, wherein the reflective layer comprises a film having alternating layers of a low refractive index material and a high refractive index material deposited thereon.

18. The windshield of claim 1, wherein the reflective layer polarizes light.

19. The windshield of claim 1, wherein the reflective layer preferentially reflects a particular polarization of light.

20. The windshield of claim 1, wherein the reflective layer comprises a film having alternating layers of a low refractive index polymer and a high refractive index polymer.
